(19) United States
(12) Patent Application Publication
(10) Pub. No.: US 2011/0062145 A1
(43) Pub. Date: Mar. 17, 2011

(54) DRYING HEATER, HEATING UNIT FOR DRYING LAUNDRY USING THE SAME, DRYING CONTROL SYSTEM AND CONTROL METHOD THEREOF

(75) Inventors: Jae Suk Yang, Gyeonggi-Do 415-040 (KR); Hyun chul Lim, Gyeonggi-Do,423-704 (KR); Sang Dong Jeong, Gyeonggi-Do, 415-040 (KR); Soung Ho Jang, Gyeonggi-Do ,415-883 (KR); Myoung Soo Kim, Seoul, 156-051 (KR); Soonn ki Kwon, Gyeonggi-Do, 423-030 (KR); Sung Chul Yang, Seoul, 157-010 (KR)

(73) Assignee: AMO CO., LTD., KYONGGI-DO, 415-863 (KR)

(21) Appl. No.: 12/513,175

(22) PCT Filed: Sep. 8, 2008
(86) PCT No.: PCT/KR08/05300

§ 371 Date: May 1, 2009

(30) Foreign Application Priority Data
Sep. 10, 2007 (KR) 10-2007-0091635
Apr. 28, 2008 (KR) 10-2008-0039563

(51) Int. Cl. H05B 3/02

(52) U.S. Cl. 219/538

(57) ABSTRACT

Provided is a drying heater, a heating unit for drying laundry using the same, a drying control system and control method thereof that reduces electric power consumption of the drying heater to supply high temperature dry air to the inside of a drum in a washing machine or a laundry drying machine, to thus simplify structure of the drying heater and reduce a manufacturing cost. The drying control method includes the step of applying a first electric power from a first drive power supply to a drying heater when a drum internal temperature is lower than a preset temperature, and applying a second electric power from a second drive power supply which is relatively smaller than the first electric power to the drying heater when the drum internal temperature is higher than the preset temperature. The drying heater includes a surface-shaped heat generation member made of a low thermal density strip style metal thin plate.

### TECHNICAL FIELD

The present invention relates to a drying heater, a heating unit for drying laundry using the same, a drying control system, and a control method thereof. More particularly, the present invention relates to a drying heater, which reduces power consumption of the drying heater to supply high temperature dry air to the inside of a drum type tub (which may be called a drum hereinafter) in a washing machine having a drying function or a laundry drying machine, and simplifies structure of the drying heater, and thus reduces a manufacturing cost of the drying heater, a heating unit for drying laundry using the same, a drying control system and a control method thereof.

### BACKGROUND ART

Usually, a washing machine is equipment for removing stains, dregs or pollutants which are stuck to clothes or bedclothes, by the action of detergents and water in a washing tub which uses torque of an electric motor, and performs a washing operation, a rinsing operation, and a dehydrating operation, in sequence, to thereby complete a washing process.

In general, the washing machine is classified into a pulsator type washing machine in which a washing tub called a pulsator type tub is vertically erected and mounted, and a drum type washing machine in which a washing tub called a drum type tub is substantially horizontally laid and mounted.

The drum type washing machine has advantages that a less amount of water is consumed, the laundry is prevented from getting tangled after washing, and damage of the laundry is less during washing.

At recent times, it is a trend that the drum type washing machines are mainly sold. The drum type washing machines are made into various types of products each including a drying-purposed heating unit therein, and thus having a dry function that dries the laundry that has been dried after washing.

Meanwhile, a laundry drying machine for drying the laundry includes a heating unit for drying the laundry by supplying high temperature dry air to the inside of a drum type tub of a washing machine into which the laundry is put, to thus separately dry the laundry which has been washed by the washing machine.

A conventional drying-purposed heating unit which is included in the washing machine or the drying machine to dry the laundry uses a sheath heater, a PTC (Positive Temperature Coefficient) heater, a nichrome wire heater or a condensing mode heater, as a heater.

FIG. 1 is a drying-purposed heating unit 1 which employs a sheath heater. As shown, the drying-purposed heating unit 1 includes a duct casing 2 having an air inlet and an air outlet to thus guide introduced air into the inside of a drum type tub, a blower fan 3 which is installed in the duct casing 2 and is made to rotate by a motor to ventilate air, and a sheath heater 4a which is mounted in the duct casing 2 to thereby heat the introduced air.

In addition, a temperature sensor 6 is installed near the air outlet and the sheath heater 4a in the duct casing 2, respectively, to thus detect ambient temperature of the air outlet and the sheath heater 4a, and to thereby control the temperature of air to be discharged, as well as to thereby prevent overheat of the sheath heater 4a.

In this case, temperature of the air heated which is supplied into the drum type tub during drying of laundry is about 90° C. to 110° C. in order to prevent damage to cloths of the laundry. The drying-purposed heating unit 1 heats air in the duct casing 2 and discharges the air heated out of the duct casing 2, so that temperature of air to be discharged via the air outlet may be kept at about 100° C.

The sheath heater 4a is a heat generation element which is formed by putting coil-shaped electric heat generation wires into a metal protective tube and sealing the metal protective tube together with magnesium oxide powder or aluminum oxide powder as an insulation element. The sheath heater 4a is strong against external physical impact. Accordingly, the sheath heater 4a may be properly bent and used according to user's usage.

In addition, the sheath heater is easily installed in comparison with a coil-shaped nichrome wires heater since a metal protective tube has been coated on the outside surface thereof. Further, the sheath heater is chemically stabilized depending upon selection of the metal protective tube. Still further, since the sheath heater is excellent in an electric insulation capability, it is used in various forms or uses as well as in a laundry drying machine.

However, the sheath heater has a structure that coil-shaped electric wires which are heat generation elements are coated by a metal protective tube through an insulation material. Accordingly, the sheath heater has a lower heat exchange efficiency than a heater which heats air passing through a duct casing with electric wires. In addition, in the case of the sheath heater, a contact surface through which is heat exchanged with external air is limited as nothing but a surface of the metal protective tube. As a result, in order to keep temperature (T_{D1}) of air that is exhausted through an air exit as 110° C., the sheath heater performs a heating operation of high temperature of 580° C. at maximum.

To review characteristics of the sheath heater in more detail, a drying test has been performed as follows. Power consumption of the sheath heater of a laundry drying machine is established into 2050 W, a drum internal temperature into 110° C., and a drying ratio into 2.5%, and then a test sample has been put into the laundry drying machine, and then a temperature characteristic graph between a heater surface temperature T_{S1} and a drum supply temperature T_{D1} has been obtained as shown in FIG. 7C.

As can be seen from the FIG. 7C graph, the peak value of the surface temperature of the heater has been risen up to about 580° C. at an initial drive time and then kept as a relatively high temperature of about 450° C. at a post-half time of a drying process, even under the condition that an airflow exists through a blower fan 3.

It can be seen that a heat insulation structure is needed around the heater from the temperature rise when considering that the maximum heat generation temperature of the sheath heater is 750° C. Further, it can be seen that structural limitation exists in order to keep a certain distance between internal components. As a result, the sheath heater may cause a loss of heat insulation cost and an increase in size of the structure.

In addition, the sheath heater employs an indirect heating method. Accordingly, it can be seen that a temperature rise speed is slow in the case that electric power is applied as shown in FIG. 7C, and a cooling rate has a slow temperature response, when the electric power is cut off.

As a result, in the case that a sheath heater having a slow temperature response is applied in a laundry drying machine, an electric power ON/OFF switching period of the heater has been about 60 cycles per second in order to keep the drum internal temperature T of a temperature sensor as 110° C., a drying time has been 3 hours 20 minutes, and electric power consumption has been 3,700 WH (see Table 1).

Therefore, the conventional laundry drying machine adopting the sheath heater has problems that a drying time increases and an amount of electric power consumption increases and thus a very expensive electricity use fare should be paid due to a slow temperature rise in the sheath heater under the conditions that optimum temperature should be maintained and a temperature rise and a cooling operation should be repeated.

In addition, the drying-purposed heating unit 1 may give damage to the drive motor of the blower fan 3 by heat that is transferred through the duct casing 2 if the drive motor of the blower fan 3 is driven for long hours and then the sheath heater 4a is not sufficiently cooled for cooling the sheath heater 4a after laundry has been completely dried. In addition, components in the neighborhood of the duct casing 2 should be designed to have heat resistance from high temperature heat of the duct casing 2. As a result, the manufacturing cost of washing machines or laundry drying machines may be additionally increased.

A heater assembly of a laundry drying machine is disclosed in Korean Patent No. 457582. In this heater assembly, a plurality of coil heaters are divided into a first coil heater group and a second coil heater group and then individually controlled to heat and dry air, and the coil heaters of the first coil heater group and the second coil heater group are respectively divided and arranged on the upper portion and the lower portion of a plate. Accordingly, even in the case that electric power is applied to only one of the first coil heater group and the second coil heater group, a drying performance of the laundry drying machine may be heightened and part of a heater case may be prevented from being concentratively heated.

The heater assembly employs the two coil heater groups which are respectively integrally operated, and which are individually controlled using a single driving power source. In addition, the two coil heater groups are operated individually or simultaneously, according to laundry to be dried.

In addition, various technologies of making a heater assembly using a coil-shaped high temperature heat generation element are disclosed in U.S. Pat. Nos. 4,531,017, 4,617,547, 4,675,511, 5,324,919, 5,329,098, and 5,895,597.

For example, in a heater assembly using a coil-shaped heat generation element in U.S. Pat. No. 4,617,547 among them, a plurality of insulators are assembled with a holding device whose both ends are supported, and then a coil-shaped high temperature heat generation element is installed in the plurality of the insulators, respectively. Accordingly, the U.S. Pat. No. 4,617,547 proposes a structure that a support frame and housing structure may be simple, a coil may be easily assembled to thus make an assembly performance excellent, and a manufacturing cost may be reduced.

However, in the case that the coil-shaped heat generation element is used, the U.S. Pat. No. 4,617,547 has problems that may cause an increase in a manufacturing cost due to using the plurality of the insulators, and a low safety and a low efficiency due to the high temperature heat generation and the high power consumption.

Meanwhile, Korean Patent Laid-open Publication No. 2006-14485 discloses a drying apparatus using a surface-shaped heat generation element which equally dries laundry, and whose thermal efficiency is excellent and structure is simple. The drying apparatus includes a drying space containing objects to be dried, and a surface-shaped heat generation element which is installed at one internal surface of the drying space and directly heating the inside of the drying space, in order to dry the objects to be dried. The surface-shaped heat generation element a thin-plate-shaped carbon heat generation element, electrodes which are installed at one and the other sides of the carbon heat generation element, to thus apply electricity to the carbon heat generation element, and an insulation coating material which is coated on both surfaces of the carbon heat generation element.

However, since the drying apparatus of the Korean Patent Laid-open Publication No. 2006-14485 includes the surface-shaped heat generation element incorporated in the inside of the drying space, it may not be easily applied to a general laundry drying machine or wash drier.

In the case of the conventional laundry drying machine, the drum internal temperature is detected, and thus an electric power supply for a heater is intercept if the detected drum internal temperature reaches a preset temperature, and the electric power supply for the heater is resumed if the detected drum internal temperature falls below a preset temperature, so that the drum internal temperature can be constantly maintained. That is, the drum internal temperature is controlled in an ON/OF switching mode. A microcomputer may detect and control the drum internal temperature, using a temperature sensor. Otherwise, the microcomputer may detect and control the drum internal temperature, using a thermostat whose circuit is opened and closed at preset temperatures, respectively.

The electric heater which is used for the conventional laundry drying machine or wash drier, or the electric heater which is used for heating a general object to be dried, uses a coil-shaped heat generation element having a high thermal density, a slow or late temperature response, and a high temperature heat generation requirement. However, since most of the high temperature heat-generation-style heat generation elements are made of alloy expensive metal such as Ni, a manufacturing cost may increase and high electric power consumption may be required.

### DISCLOSURE

### Technical Problem

To solve the above problems, it is an object of the present invention to provide a drying heater which employs a strip style surface-shaped heat generation member made of a metal thin film whose temperature response feature is fast, which is driven at low temperature, and whose heat exchanged area is large, as a heat generation member, to thus heighten a heat exchange efficiency with air, to thereby prevent inefficient electric power consumption which may be caused by high temperature heat generation by employing a low temperature heat generation drive system, and to accordingly reduce electric power consumption by optimizing electric power consumption, a heating unit for drying laundry using the same, and a drying control system using the same.

It is another object of the present invention to provide a drying machine control system and method which employs a strip style surface-shaped heat generation member made of a metal thin film, and which switches level of a drive voltage into two stages according to a drum internal temperature, and which applies the switched drive voltage to a heater, to thus intercept the temperature of the heater from descending below a certain temperature and control drum internal temperature to be changed insignificantly.

It is still another object of the present invention to provide a drying machine control system and method which employs a strip style surface-shaped heat generation member made of a metal thin film whose temperature response feature is fast and which is driven at low temperature, as a heat generation member, and whose high-level drive voltage period is shortened and low-level drive voltage period is lengthened and simultaneously a drive voltage switching period is lengthened according to proceeding of an operating time, when level of the drive voltage is switched into multiple stages according to drum internal temperature.

It is yet another object of the present invention to provide a laundry drying-purposed heating unit which employs a strip style surface-shaped heat generation member made of a metal thin film whose temperature response feature is fast and which is driven at low temperature, as heat generation elements, and which intercepts temperature of a heater from descending below a certain temperature to thus control drum internal temperature to be changed insignificantly, in a manner of controlling the number of the heat generation elements to which a drive voltage is applied according to the drum internal temperature, and a drying machine control system and method using the same.

It is yet still another object of the present invention to provide a drying heater and a laundry drying-purposed heating unit using the same, which can shorten a laundry drying time and reduce unnecessary electric power consumption by reducing an initial response time.

It is yet still another object of the present invention to provide a drying heater and a laundry drying-purposed heating unit using the same, in which a duct casing and components in the neighborhood of the duct casing can be made of a general synthetic resin, since a heat generation temperature of a heater is low, and the whole size of the unit can be made compact.

It is yet still another object of the present invention to provide a method of controlling a drying heater so that the internal temperature of a drum type tub for use in a laundry drying machine or wash drier can be maintained at a preset temperature.

### Technical Solution

To accomplish the above object of the present invention, according to an aspect of the present invention, there is provided a unit heater for use in a drying heater, the unit heater comprising:

a plate style base member having a thermal conductivity and an electric insulation feature; and

a low thermal density strip style surface-shaped heat generation member which is mounted on the plate style base member, and which is formed of a strip which is obtained by slitting a metal thin plate, to thus perform a heat generation operation when electric power is applied to both ends of the strip.

Preferably but not necessarily, the surface-shaped heat generation member is corrugated.

Preferably but not necessarily, the base member is formed of a number of coupling throughholes in a number of rows, in correspondence to width of the surface-shaped heat generation member, and the corrugated surface-shaped heat generation member is partially coupled with the number of the coupling throughholes of the base member.

Preferably but not necessarily, in the case of the surface-shaped heat generation member, the lower portion of an upper surface-shaped heat generation member located at the upper side of the base member and the upper portion of a lower surface-shaped heat generation member located at the lower portion of the base member are respectively coupled with the number of the coupling throughholes on upper and lower surfaces of the base member, in turn.

Preferably but not necessarily, the base member may be made of mica, or aluminum or an aluminum alloy on the surface of which an alumina insulation film is formed.

Preferably but not necessarily, the surface-shaped heat generation member may be made of a FeCrAl-group alloy thin plate, and an alumina insulation film and a ceramics coating film are formed on the surface of the surface-shaped heat generation member.

According to another aspect of the present invention, there is also provided a drying heater comprising:

a vessel-shaped housing; and

a number of unit heaters which are formed at intervals in the inside of the housing,

wherein the number of the unit heaters respectively comprise:

a plate style base member having a thermal conductivity and an electric insulation feature; and

a low thermal density strip style surface-shaped heat generation member which is mounted on the plate style base member, and which is formed of a strip which is obtained by slitting a metal thin plate, to thus perform a heat generation operation when electric power is applied to both ends of the strip.

Preferably but not necessarily, the base member is formed of a number of coupling throughholes in a number of rows, in correspondence to width of the surface-shaped heat generation member, the surface-shaped heat generation member is corrugated, and the upper and lower sides of the corrugated surface-shaped heat generation member are partially coupled with the number of the coupling throughholes of the base member, on upper and lower surfaces of the base member.

Preferably but not necessarily, the base member may be made of mica, or aluminum or an aluminum alloy on the surface of which an alumina insulation film is formed, the surface-shaped heat generation member may be made of a FeCrAl-group alloy thin plate, and the FeCrAl-group alloy thin plate is formed into a thickness of 20 to 500 μm.

According to still another aspect of the present invention, there is also provided a laundry drying-purposed heating unit comprising:

a duct casing member having an air inlet and an air outlet at both ends thereof, to thus form a path of guiding inhaled air into a drum;

a blower which is mounted in the inside of the duct casing member and which inhales air via the air inlet to then ventilate the inhaled air via the air outlet;

a drying heater which is mounted in the inside of the duct casing member and which heats air passing through an inner path,

wherein the drying heater comprises: a vessel-shaped housing; and

a number of unit heaters which are formed at intervals in the inside of the housing,

wherein the number of the unit heaters respectively comprise:

a plate style base member having a thermal conductivity and an electric insulation feature; and

a low thermal density strip style surface-shaped heat generation member which is mounted on the plate style base member, and which is formed of a strip which is obtained by slitting a metal thin plate, to thus perform a heat generation operation when electric power is applied to both ends of the strip.

According to yet another aspect of the present invention, there is also provided a drying control system which supplies air heated at a preset temperature for the inside of a drum in a laundry drying machine or a wash drier, in order to dry laundry, the drying control system comprising:

a first drive power supply for applying a first electric power;

a second drive power supply for applying a second electric power that is lower relatively than the first electric power;

a drying heater having a surface-shaped heat generation member made of a low thermal density strip style metal thin plate;

a temperature sensor which detects drum internal temperature of the drying machine or wash drier; and

a controller which controls the first electric power of the first drive power supply to be applied to a drying heater in the case that the drum internal temperature is lower than a preset temperature, and controls the second electric power of the second drive power supply to be applied to the drying heater in the case that the drum internal temperature is higher than the preset temperature.

Preferably but not necessarily, the drying control system further comprises a switching unit which selectively applies any one of the first and second electric power to the drying heater according to a control signal that is applied from the controller.

Preferably but not necessarily, the voltage applied from the first drive power supply is AC 220V, and the voltage applied from the second drive power supply is AC 120V.

Preferably but not necessarily, the first electric power of the first drive power supply is established as a capacity which heats the drying heater and raises the drum internal temperature above the preset temperature, and the second electric power of the second drive power supply is established as a capacity which cannot raise the drum internal temperature above the preset temperature, when the drying heater is heated by only the second drive power supply.

Preferably but not necessarily, the drying heater may include a number of unit heaters which are laminated and layered at intervals in the inside of a vessel-shaped housing, in which a surface-shaped heat generation member made of a metal thin plate is mounted in a plate style base member, respectively.

Preferably but not necessarily, the surface-shaped heat generation member is corrugated.

Preferably but not necessarily, the drying heater comprises:

a vessel-shaped housing; and

a number of unit heaters which are formed at intervals in the inside of the housing,

wherein the number of the unit heaters respectively comprise:

a plate style base member having a thermal conductivity and an electric insulation feature; and

a surface-shaped heat generation member which is formed of a metal thin plate and is insulated and mounted on the plate style base member, and which receives the electric power to thus perform a heat generation operation.

Preferably but not necessarily, the number of the unit heaters may further comprise a corrugation style heat radiation member which is made of a thermal conductive material and is mounted on the upper portion of the surface-shaped heat generation member, respectively.

Preferably but not necessarily, the number of the unit heaters may further comprise a plate style thermal conductive member which is made of a thermal conductive material and contacts between the surface-shaped heat generation member and the corrugation style heat radiation member, in an insulated form.

According to still yet another aspect of the present invention, there is also provided a drying control system which supplies air heated at a preset temperature for the inside of a drum in a laundry drying machine or a wash drier, in order to dry laundry, the drying control system comprising:

a single drive power supply;

a first drying heater which has a surface-shaped heat generation member made of a low thermal density strip style metal thin plate, and which performs a heat generation operation in correspondence to a first electric power when an electric power is applied from the drive power supply;

a second drying heater which has a surface-shaped heat generation member made of a low thermal density strip style metal thin plate, and which performs a heat generation operation in correspondence to a second electric power that is relatively higher than the first electric power when the electric power is applied from the drive power supply;

a temperature sensor which detects drum internal temperature of the drying machine or wash drier; and

a controller which controls the electric power of the drive power supply to be simultaneously applied to the first and second drying heaters in the case that the drum internal temperature is lower than a preset temperature, and controls the electric power of the drive power supply to be applied to only the first drying heater in the case that the drum internal temperature is higher than the preset temperature.

Preferably but not necessarily, the drying control system may further comprise a switching unit which simultaneously applies the electric power to both the first and second drying heaters, or applies the electric power to only the first drying heater, according to a control signal that is applied from the controller.

Preferably but not necessarily, the first and second drying heaters are connected in series to or in parallel with each other.

Preferably but not necessarily, when the first and second drying heaters are connected in parallel with each other, the first drying heater is connected directly to the drive power supply and the second drying heater is connected in the drive power supply through the switching unit that is established in a turn-on state selectively by the controller.

Preferably but not necessarily, when the first and second drying heaters are connected in series to each other, a connection point between the first and second drying heaters and one end of the second drying heater is connected to the drive power supply through the switching unit.

According to a further aspect of the present invention, there is also provided a drying control method which supplies air heated at a preset temperature for the inside of a drum in a laundry drying machine or a wash drier, in order to dry laundry, the drying control method comprising:

supplying heated air for the inside of a drum of the laundry drying machine or wash drier by simultaneously applying the drive electric power to a first drying heater having a surface-shaped heat generation member made of a low thermal density strip style metal thin plate when an operation of the laundry drying machine or wash drier is initiated, and which performs a heat generation operation in correspondence to a first electric power when an electric power is applied from the drive power supply, and a second drying heater having a surface-shaped heat generation member made of a low thermal density strip style metal thin plate which performs a heat generation operation in correspondence to a second electric power which is relatively higher than the first electric power when the electric power is applied from the drive power supply;

detecting drum internal temperature of the laundry drying machine or wash drier; and

applying the electric power to both the first and second drying heaters when the drum internal temperature is lower than a preset temperature, or applying the electric power to only the first drying heater when the drum internal temperature is higher than the preset temperature.

Preferably but not necessarily, the first and second drying heaters are connected in series to or in parallel with each other.

According to a still further aspect of the present invention, there is also provided a drying control method which supplies air heated at a preset temperature for the inside of a drum in a laundry drying machine or a wash drier, in order to dry laundry, the drying control method comprising:

supplying heated air for the inside of a drum of the laundry drying machine or wash drier by applying a first electric power from a first drive power supply to a drying heater having a surface-shaped heat generation member made of a low thermal density strip style metal thin plate when an operation of the laundry drying machine or wash drier is initiated;

detecting drum internal temperature of the laundry drying machine or wash drier; and

applying the first electric power from the first drive power supply to a drying heater when the drum internal temperature is lower than a preset temperature, or applying a second electric power from a second drive power supply to the drying heater when the drum internal temperature is higher than the preset temperature in which the second electric power is relatively lower than the first electric power.

Preferably but not necessarily, the voltage applied from the first drive power supply is AC 220V, and the voltage applied from the second drive power supply is AC 120V.

Preferably but not necessarily, the first electric power of the first drive power supply is established as a capacity which heats the drying heater and raises the drum internal temperature above the preset temperature, and the second electric power of the second drive power supply is established as a capacity which cannot raise the drum internal temperature above the preset temperature, when the drying heater is heated by only the second drive power supply.

Preferably but not necessarily, in the case of the drying heater, a proportion of a second period for which the second electric power of the second drive power supply is applied with respect to a first period for which the first electric power of the first drive power supply is applied increases according to passage of the drying time, and a period for which the first period and the second period are repeated increases.

Preferably but not necessarily, the drying heater may include a number of unit heaters which are laminated and layered at intervals in the inside of a vessel-shaped housing, in which a surface-shaped heat generation member made of a metal thin plate is mounted in a plate style base member, respectively.

According to a yet further aspect of the present invention, there is also provided a drying control method which controls a drying heater so that drum internal temperature of a drum in a laundry drying machine or a wash drier can be maintained at a preset temperature, the drying control method comprising:

applying a first electric power from a first drive power supply to the drying heater when the drum internal temperature is lower than the preset temperature, and applying a second electric power from a second drive power supply to the drying heater when the drum internal temperature is higher than the preset temperature in which the second electric power is relatively lower than the first electric power.

Preferably but not necessarily, the drying heater comprises a surface-shaped heat generation member made of a low thermal density strip style metal thin plate.

According to a yet still further aspect of the present invention, there is also provided a drying control method which controls a drying heater so that drum internal temperature of a drum in a laundry drying machine or a wash drier can be maintained at a preset temperature, the drying control method comprising:

applying an electric power to both first and second drying heaters when the drum internal temperature is lower than a preset temperature, and applying the electric power to only the first drying heater when the drum internal temperature is higher than the preset temperature.

Preferably but not necessarily, the first drying heater comprises a surface-shaped heat generation member made of a low thermal density strip style metal thin plate, and performs a heat generation operation corresponding to a first electric power when the electric power is applied thereto, and the second drying heater comprises a surface-shaped heat generation member made of a low thermal density strip style metal thin plate, and performs a heat generation operation corresponding to a second electric power relatively higher than the first electric power when the electric power is applied thereto.

Preferably but not necessarily, a resistance value of the first drying heater is smaller relatively than that of the second drying heater.

### Advantageous Effects

As described above, the present invention uses a drying heater that can increase a heat exchange efficiency with air, and heat air at a sufficient temperature that can dry washes with a low temperature heat generation operation, to thereby remarkably reduce electric power consumption and an amount of consumption of power lines which is required for drying the washes, to thus reduce burden of electric charges and prevent fire outbreak due to overload, when using electric products.

In addition, the present invention can remarkably shorten a period of time for which air is heated up to a temperature necessary for drying washes, to thereby shorten time which is taken for drying the washes, and reduce electric power consumption in proportion to the shortened drying time.

In addition, the present invention can use synthetic resin materials as materials of components in the neighborhood of a heating unit as well as those of a blower fan and a duct casing for use in a drying-purposed heating unit since a heat generation temperature of a drying heater is low, to thereby a manufacturing cost of a washing machine or a laundry drying machine.

In addition, the present invention employs a strip style surface-shaped heat generation member made of a metal thin film whose temperature response feature is fast, which is driven at low temperature, and whose heat exchanged area is large, as a heat generation member, to thus heighten a heat exchange efficiency with air, to thereby prevent inefficient electric power consumption which may be caused by high temperature heat generation by supplying air of temperature sufficient for drying washes even employing a low temperature heat generation, and to accordingly reduce electric power consumption by optimizing electric power consumption.

### DESCRIPTION OF DRAWINGS

The above and other objects and advantages of the present invention will become more apparent by describing the preferred embodiments thereof in detail with reference to the accompanying drawings in which:

FIG. 1 is a perspective view showing a conventional laundry drying-purposed heating unit;

FIGS. 2A and 2B are a perspective view and a plan view showing a laundry drying-purposed drying heater from which an upper cover has been removed, and FIG. 2C is a cross-sectional view along a line X-X′ of FIG. 2B;

FIG. 3 is a diagram showing an assembly process of a unit heater which is used for a drying heater for drying laundry according to the present invention;

FIGS. 4A to 4D are perspective views that respectively illustrate a heating unit for drying laundry employing a drying heater for drying laundry according to the present invention;

FIG. 5 is a schematic block diagram showing a drying control system of a laundry drying machine according to a first embodiment of the present invention;

FIG. 6 is a flowchart view for explaining a drying control method of a drying control system illustrated in FIG. 5;

FIG. 7A is a graph showing a temperature change by time of a drying heater in the case that a multistage level control is applied in a drying heater for drying laundry according to the present invention;

FIG. 7B is a graph showing a temperature change by time of a drying heater in the case that a multistage level control is not applied in a drying heater for drying laundry according to the present invention;

FIG. 7C is a graph showing a temperature change by time of a conventional drying heater;

FIGS. 8A to 8E are graphs showing an enlarged sample by time in the temperature change graph of FIG. 7A, respectively;

FIGS. 9A and 9B are schematic block diagrams showing a drying control system of a laundry drying machine according to second and third embodiments of the present invention, respectively;

FIG. 10 is a flowchart view for explaining a drying control method of the drying control system illustrated in FIGS. 9A and 9B;

FIGS. 11A and 11B are an exploded perspective view of a unit heater and a front view of a drying heater, according to a first modification of the present invention, respectively;

FIGS. 12A and 12B are an exploded perspective view of a unit heater and a front view of a drying heater, according to a second modification of the present invention, respectively;

FIGS. 13A and 13B are an exploded perspective view of a unit heater and a front view of a drying heater, according to a third modification of the present invention, respectively;

FIGS. 14A and 14B are a perspective view and a plan view of a drying heater having a cylindrical structure according to another variation of the present invention; and

FIGS. 15A and 15B are a perspective view and a plan view of a drying heater having a cylindrical structure according to still another variation of the present invention.

### BEST MODE

Hereinbelow, a drying heater, a heating unit for drying laundry using the same, a drying control system, and a control method thereof, according to preferred embodiments of the present invention will be described with reference to the accompanying drawings. Like reference numerals denote like elements through the following embodiments. However, the detailed description of the relevant known functions or structures will be omitted when operational principles of the preferred embodiments of the present invention are described.

Hereinbelow, a washing machine having a function of drying laundry or washes having passed through a washing process is defined as a laundry drying machine. In addition to the laundry drying machine, an apparatus which only dries laundry or washes is defined as a washes drier.

Usually, a laundry drying machine is assembled in a manner that a drying-purposed heating unit is included in a circulation duct communicating with the inside of a drum in the inside of the whole housing, and a washes drier is assembled in a manner that a drying-purposed heating unit is in the outside of the rear surface of a housing to thus supply drying-purposed heated air in to the inside of the drum. However, it is possible to employ a structure that a drying-purposed heating unit is included in a circulation duct communicating with the inside of a drum in the inside of the whole housing even in the washes drier.

The present invention provides a drying-purposed heating unit and a drying heater which is used in the drying-purposed heating unit, and can be applied to the laundry drying machine and the washes drier. Hereinbelow, a case that the present invention is chiefly applied to a laundry drying machine will be described in the following embodiments of the present invention.

A. Drying Heater

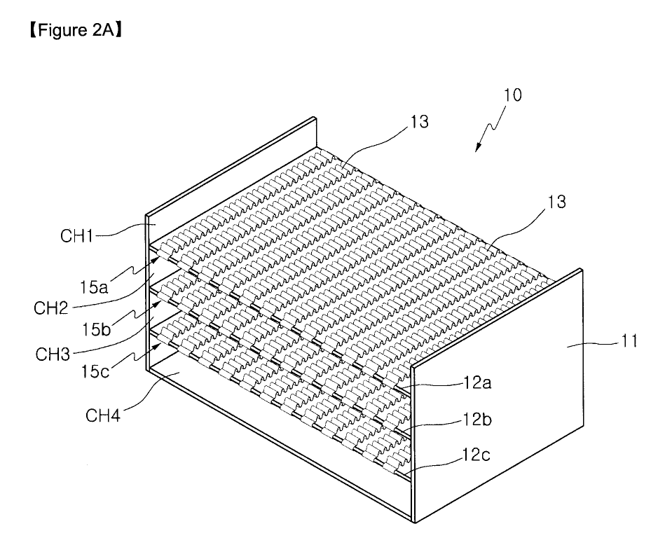

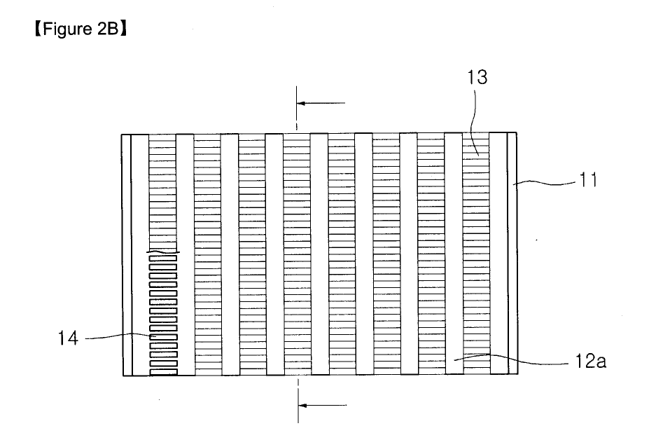

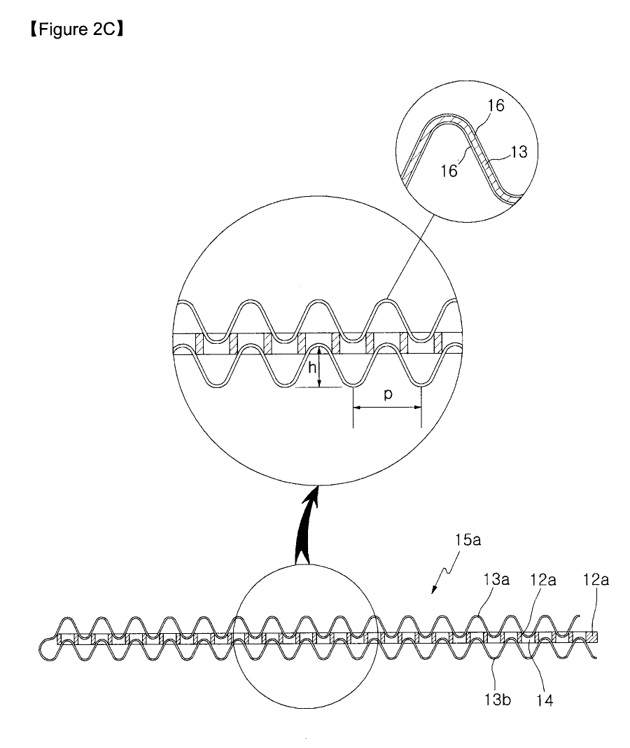

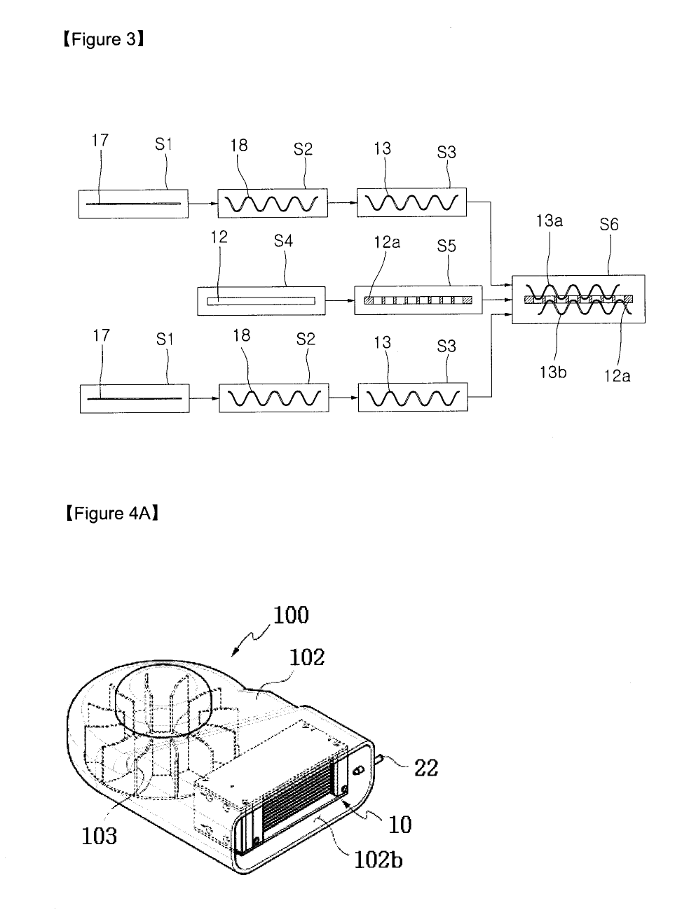

FIGS. 2A and 2B are a perspective view and a plan view showing a laundry drying-purposed drying heater from which an upper cover has been removed, and FIG. 2C is a cross-sectional view along a line X-X′ of FIG. 2B, and FIG. 3 is a diagram showing an assembly process of a unit heater which is used for a drying heater for drying laundry according to the present invention.

As illustrated in FIG. 2A, a drying heater 10 for drying laundry according to an embodiment of the present invention includes a number of plate style base members, for example, three plate style base members 12a-12c which are installed at certain intervals in parallel with one another, in a rectangular vessel-shaped housing 11 for example, so that a number of channels CH1-CH4 through which air passes in the housing 11. It is desirable that the housing 11 is made of a metallic material. The base members 12a-12c are used as bases for a heater, and may be made of a material whose thermal conductivity is excellent and whose electrical insulation performance with respect to a heater is excellent, for example, mica.

A coupling between the base members 12a-12c and the housing 11 may be accomplished by for example a snap coupling structure of a protrusions-and-coupling holes-mode, a structure that lengthy grooves are in advance formed on the inner surface of the housing with which the base members 12a-12c are coupled and then both ends of the base members 12a-12c are slidingly coupled into the grooves, respectively, or a well-known coupling method. Unless an assembly reliability drops greatly, any coupling structure between the base members 12a-12c and the housing 11 may be applied.

A number of throughholes 14 are formed in a number of rows at certain intervals, in the base members 12a-12c, respectively, in the same directions as those of the channels or in the directions perpendicularly with the channels. As illustrated in FIG. 2C, a strip style surface-shaped heat generation member 13 is compressively coupled with a number of throughholes 14 which are formed in the respective base members 12a-12c, respectively, and supported on the upper and/or lower surfaces of the respective base members 12a-12c. The strip style surface-shaped heat generation member 13 is formed by corrugating a metal thin plate, to thus widen a contact area with air. Here, height and pitch of the corrugation is determined considering a resistance value.

The strip style surface-shaped heat generation member 13 includes an upper surface-shaped heat generation member 13a located at the upper side of the respective base members 12a-12c and a lower surface-shaped heat generation member 13b located at the lower side of the respective base members 12a-12c. It is desirable that the lower and upper portions of the strip style surface-shaped heat generation member 13 are sequentially coupled with the coupling throughholes 14.

In addition, it is desirable that the upper surface-shaped heat generation member 13a and the lower surface-shaped heat generation member 13b are connected in series to increase a resistance value that is proportional with length of the upper and lower surface-shaped heat generation members 13a and 13b. However, depending upon an increase in a drying capacity of a drying machine, the upper surface-shaped heat generation member 13a and the lower surface-shaped heat generation member 13b may be connected in parallel with each other, or connected in a combination of a series connection and a parallel connection.

In the above-described embodiment, first to third unit heaters 15a-15c, that is, three unit heaters 15a-15c are formed in which the strip style surface-shaped heat generation member 13, that is, the upper surface-shaped heat generation member 13a and the lower surface-shaped heat generation member 13b are coupled with the upper and lower surfaces of the first to third base members 12a-12c, that is, three base members 12a-12c. However, the number of the unit heaters 15a-15c may be varied according to capacity of the heater. A mutual connection structure of the unit heaters 15a-15c may be configured by a series connection, a parallel connection or a combination of series and parallel connections.

The strip style surface-shaped heat generation member 13 performs a heat generation operation when electric power is applied thereto. It is desirable that a ceramics layer 15 is coated on the surface of the strip style surface-shaped heat generation member 13, so that electrical insulation is achieved between the adjoining surface-shaped heat generation members 13.

B. Unit Heater Manufacturing Process

A manufacturing process of the unit heater 15a will be described with reference to FIG. 3.

The strip style surface-shaped heat generation member 13 used in the present invention is made of any one of a single element (Fe, Al, Cu, etc.) metal thin plate, a Fe—X and Fe—Cr metal thin plate, and a FeCrAl alloy thin plate such as Fe-(14-21%)Cr-(2-10%)Al.

A Fecalloy alloy (called KANTHAL™ line) or Fe-20Cr-5Al-REM (rare earth metal) (here, including about REM (Y, Hf, Zr) of 1%) which is synthesized at the rate of Fe-15Cr-5Al may be used as a desirable alloy material of the FeCrAl alloy thin plate.

A more desirable material of the strip style surface-shaped heat generation member 13 is Fe-15Cr-5Al. When heat treatment is performed on the surface of the strip style surface-shaped heat generation member 13 made of Fe-15Cr-5Al, Al₂O₃ alumina insulation film is formed on the surface of the strip style surface-shaped heat generation member 13. Thus, the strip style surface-shaped heat generation member 13 has a high temperature corrosion resistance capability, to thereby provide an advantage of solving an oxidation problem of iron-group materials inexpensively.

However, the strip style surface-shaped heat generation member 13 may be formed of a thin plate with a specific resistance value which is required as characteristics of a heat wire material. If a material is inexpensively available, any metal or alloy material may be used as the strip style surface-shaped heat generation member 13.

For example, a material which is processed as a thin film of 20-500 μm in thickness is used as the metal thin plate so as to have a fast temperature response feature. The this thin plate has a surface area more than 10-20 times when compared with other coil-shaped heat wires having an equal cross-sectional area. Accordingly, when heat generation is accomplished using an equal electric power, a thermal density which occurs per 1 cm² is low, and thus an amount of calory is also low. Thus, low temperature heat generation is accomplished in a large area. As a result, the material which is processed as a thin film of 20-500 μm in thickness is appropriate for a low temperature heating material.

Therefore, since the strip style surface-shaped heat generation member 13 that is employed in the present invention is formed of a metal thin plate strip having a low thermal density, it may perform relatively lower temperature heat generation in comparison with a relatively thick surface-shaped heat generation member or coil style heating element, and also perform heat exchange in a large superficial area. Further, it is possible to take the advantage of a fast temperature response property to thereby reduce electric power consumption.

Meanwhile, in the present invention, for example, considering thickness and width of the thin plate strip in addition to conditions which are determined in advance like a laundry drying capacity, a laundry drying time, and an air temperature of air supplied into the inside of a drum, length of the thin plate strip is suitably determined. That is, if thickness and width of the metal thin plate strip are determined, a resistance value is calculated which is determined according to a desired capacity of a heater (that is, electric power consumption) because of a known resistance value per a unit length, to thus determined length of the thin plate strip.

If the length of the thin plate strip is determined through the above-described resistance value calculation process, the thin plate of a broad width is slitted, to thus prepare a strip 17 having a width which has been determined beforehand (S1). For example, a heater capacity (that is, electric power consumption) is established as 2000 w, as in a first embodiment to be described later. In the case that the metal thin plate formed of Fe-15Cr-5Al is manufactured into a strip of 50 μm thick and 5 mm wide, length of the strip is set to be about 1.2 m.

Considering size of a housing 11 and length of the strip 17 that are allowed for the drying heater, a corrugation (waveform that peaks and valleys are repeated) processing work is executed, to thus form a corrugation strip 18 (S2). In this case, height “h” of each peak and pitch “p” between the valleys of the corrugation strip 18 is set taking into consideration the number of base members 12a-12c and a bond area of the surface-shaped heat generation member where the base members 12a-12c and the surface-shaped heat generation member are installed in the housing 11. The corrugation may be formed as a sinusoidal wave shape, a square wave shape or a triangular shape.

Then, the strip style surface-shaped heat generation member 13 is formed by coating both the surfaces of the corrugation strip 18 using ceramics powder mixed with a well-known bonding agent so as to be electrically insulated with respect to the corrugation strip 18, sintering the coated corrugation strip 18 to then form a ceramics layer 15 on the external surface of the corrugation strip 18 (S3).

Meanwhile, the base member 12a is obtained by cutting a thin plate made of mica depending on a channel width of the housing 11 (S4), and perforating a number of throughholes 14 at intervals of the half of the corrugation pitch “p” in the cut mica thin plate 12 (S5).

After that, a pair of surface-shaped heat generation members 13a and 13b are alternately assembled into throughholes 14 formed in the upper and lower portions of the base member 12a (S6), to thus obtain a unit heater 15a.

In this case, a number of surface-shaped heat generation members 13 which are assembled in a number of different rows, as well as the pair of surface-shaped heat generation members 13a and 13b which have been assembled in the base member 12a, are mutually connected in series.

A number of unit heaters 15a-15c which are assembled in the above-described manner are assembled in the housing 11 as shown in FIG. 2a, to thereby form a drying heater 10. Here, the respective surface-shaped heat generation members 13 may be connected in series or in parallel with each other. Alternatively, the respective surface-shaped heat generation members 13 may be connected in a combination of a series connection and a parallel connection so as to meet a preset operating power.

C. Drying-Purposed Heating Unit

Meanwhile, the drying heater 10 is included in a drying-purposed heating unit 100 which is installed in a laundry drying machine or a wash drier, and blows heated dry air into the inside of a drum type tub.

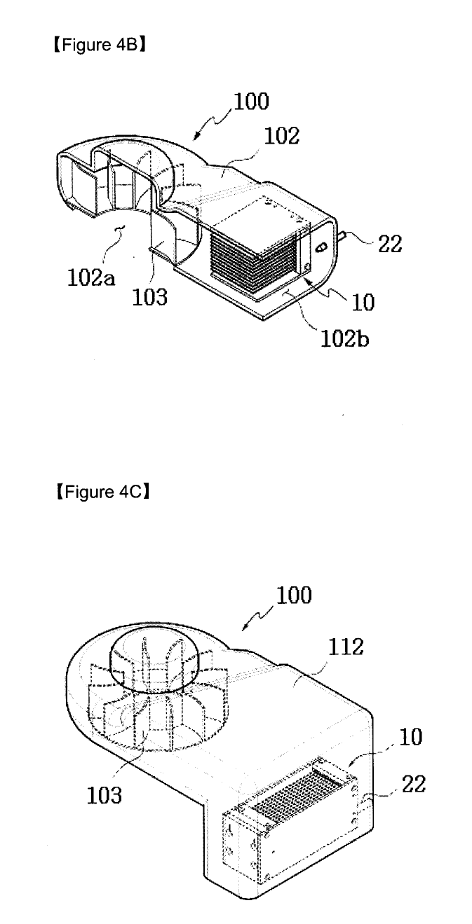

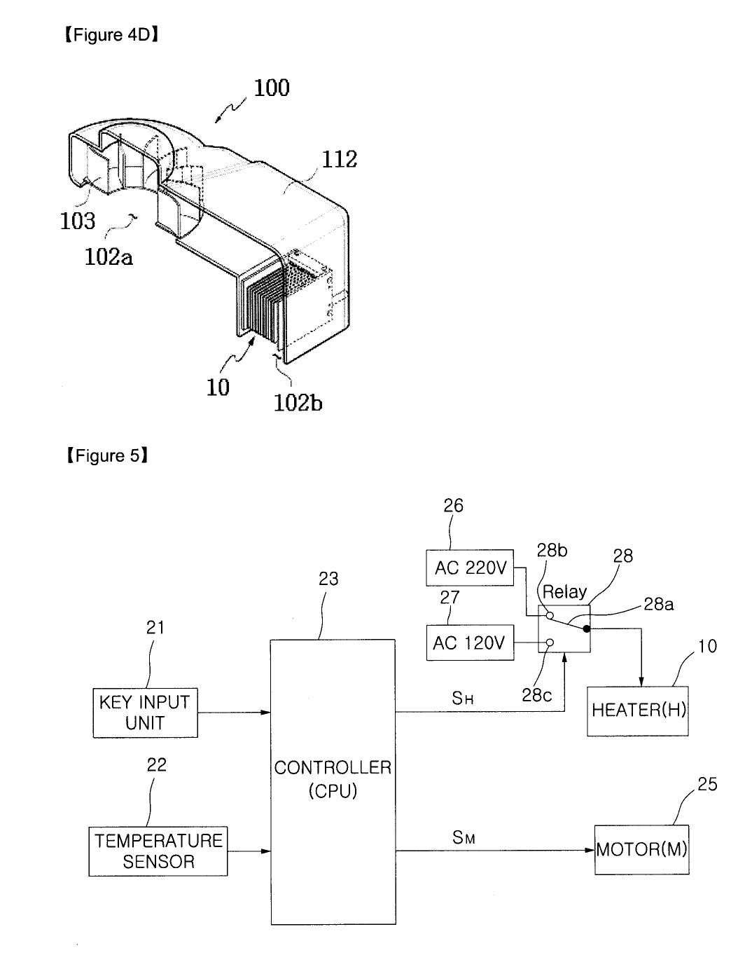

As shown in FIGS. 4A and 4B, the drying-purposed heating unit 100 includes a duct casing 102 having an air inlet 102a and an air outlet 102b to thus guide introduced air into the inside of a drum type tub which is called a drum (not shown), a blower fan 103 which is installed in the duct casing 102 and is made to rotate by a motor (M) 25 of FIG. 5 to ventilate air, and a drying heater 10 which is mounted in the duct casing 102 to thereby heat the introduced air.

In addition, a temperature sensor 22 is installed near the air outlet 102b in the duct casing 102, to thus detect temperature of the air discharged into the drum and to then the detected temperature value to a controller (CPU) 23. The temperature sensor 22 may be installed in the inside the drum instead of the air outlet 102b, to thus detect the drum internal temperature.

The drying heater 10 may have the structure of the embodiment or a structure of another embodiment to be described later.

In the case of the drying-purposed heating unit 100 as illustrated in FIGS. 4A and 4B, the duct casing 102 is formed in a linear structure, and the drying heater 10 and the blower fan 103 are put in a straight line in the duct casing 102. Air is introduced in by rotation of the blower fan 103, and the introduced air is heated by the drying heater 10. Then, the heated dry air is discharged in one direction into the inside of the drum.

In addition, as illustrated in FIGS. 4C and 4D, the drying-purposed heating unit 100 according to the present invention may be achieved into a structure that a duct casing 112 is bent at right angle, and a drying heater 10 and a blower fan 103 are placed at both ends of the duct casing 112 that has been bent at right angle.

Therefore, the drying heater 10 and the blower fan 103 are positioned to form an angle of 90 degrees. Air is introduced in by rotation of the blower fan 103, and the introduced air is heated by the drying heater 10. Then, the heated dry air is discharged in one direction into the inside of the drum. Here, an air flow is changed by 90 degrees to then be discharged.

In the above-described embodiment, the drying-purposed heating unit 100 according to the present invention has a structure that the drying heater 10 and the blower fan 103 are assembled together in the inside of the duct casing 102, but the drying heater 10 cannot be separated from the blower fan 103 and cannot be installed individually from the blower fan 103. That is, the drying heater 10 may be installed in the air inlet of the drum, and the blower fan 103 may be installed in the air outlet of the drum.

D. Drying Control System and Control Method Thereof

### First Embodiment

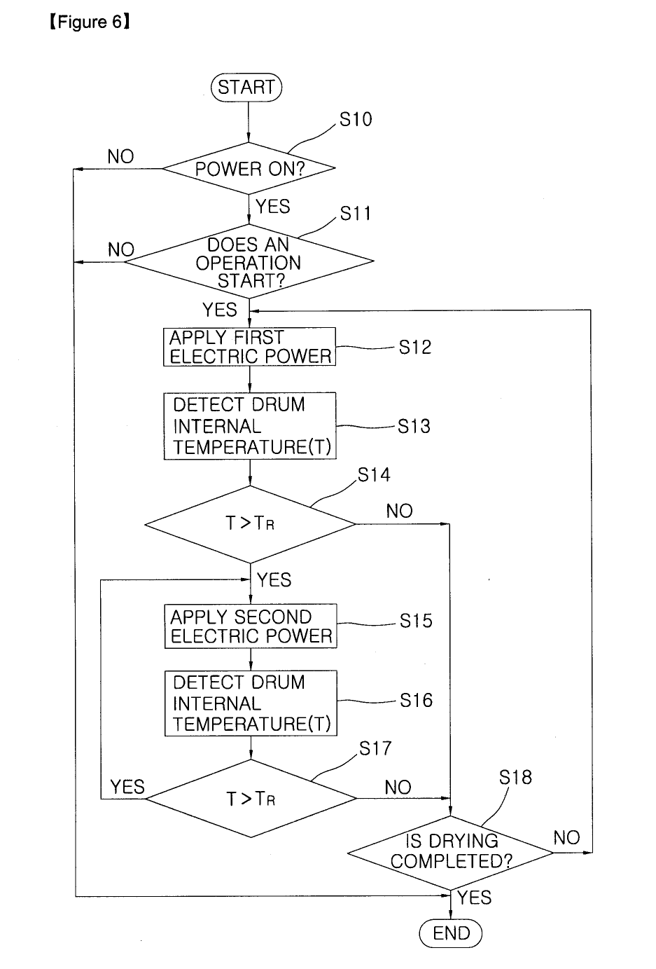

FIG. 5 is a schematic block diagram showing a drying control system of a laundry drying machine according to a first embodiment of the present invention, and FIG. 6 is a flowchart view for explaining a drying control method of the drying control system illustrated in FIG. 5.

Referring to FIG. 5, the drying control system of the laundry drying machine according to the first embodiment of the present invention includes: a key input unit 21 having a number of keys for inputting user's request commands; a temperature sensor 22 for detecting a drum internal temperature (T) of the laundry drying machine according to an operation on/off command which is input via the key input unit 21; and a controller (CPU (Central Processing Unit)) 23 which generates a heater control signal S_{H} for driving a heater (H) and simultaneously a blower motor driving signal S_{M} for driving a blower fan 103, based on the current drum internal temperature (T) detected from the temperature sensor 22, if an operation start command is input via the key input unit 21.

The controller 23 may employ for example a microcomputer having a first memory (for example, ROM (Read Only Memory)) storing a control program for executing a drying control method shown in FIG. 6, and a second memory (for example RAM (Random Access Memory)) storing temporary data during processing, or another well-known signal processing unit in which a memory device is detached from a processor.

To the output of the controller (CPU) 23 are connected a switching unit 28 which makes the output of the switching unit 28 connected to any one of first and second electric power supplies 26 and 27 which is applied to a drying heater 10, by making a moving contact 28a connected to any one of first and second electric power supplies 26 and 27, according to a logic level of the heater control signal S_{H}, that is, “0” and “1” and a blower motor (M) 25 to drive the blower fan 103 according to the blower motor driving signal S_{M} for driving the blower fan 103.

As illustrated in the FIG. 5, the switching unit 28 is composed of a relay. Otherwise, a component such as a SCR (Silicone Controller Rectifier) and a TRIAC (triode AC switch) which are suitable for switching AC power may be used for the switching unit 28.

In the case that a relay is used as the switching unit 28, for example, an electric power of an AC (Alternating-current) voltage of 220V and an electric current of 9.0 A from the first driving power supply 26 is applied to a first input 28b that is a B contact point of the relay, and an electric power of an AC (Alternating-current) voltage of 120V and an electric current of 4.95 A from the second driving power supply 27 is applied to a second input 28c that is an A contact point of the relay. The other end of the moving contact 28a is connected to the heater (H) I0.

In this case, the relay 28 makes the AC (Alternating-current) voltage of 220V from the first driving power supply 26 applied to the drying heater 10, in the case that a logic level of the heater control signal S_{H} is “0”, and the relay 28 makes the AC (Alternating-current) voltage of 120V from the second driving power supply 27 applied to the drying heater 10, in the case that a logic level of the heater control signal S_{H} is “1.”

Thus, an operation of the laundry drying machine having the above-described structure according to the present invention will be described with reference to FIG. 6.

First, a user turns on an electric power supply via the key input unit 21. The electric power is supplied and operation of the laundry drying machine is at a stand-by state (S10).

Then, if the user selects a laundry drying condition through the key input unit 21, and then presses an operation key so as to start a drying operation (S11), the controller 23 recognizes user commands and supplies a heater control signal S_{H} and a blower motor driving signal S_{M} to the switching unit 28 and the blower motor 25, respectively, to thus make the drying heater 10 and the blower motor 25 operate and simultaneously receives a drum internal temperature (T) via the temperature sensor 22 (S12 and S13).

When the laundry drying machine is at an initial state, the controller 23 generates a signal that the logic level of the heater control signal S_{H} is “0” to then be supplied to the switching unit 28. Thus, in the case that a relay is used as the switching unit 28, the moving contact 28a of the relay is connected to the first input 28b that is the B contact pint of the relay, and the first voltage and the first electric current (that is, the first electric power) from the first drive power supply 26, for example, the first electric power of AC voltage of 220V and electric current of 9.0 A is applied to the drying heater 10. That is, the electric power that is applied to the drying heater 10 from the first drive power supply 26 is established into about 2000 W. The applied electric power is established similarly to the power consumption used in a general laundry drying machine.

The drying heater 10 is operated according to application of the first voltage to thereby generate heat. Then, the blower motor 25 is operated, to thereby make air introduced by the blower fan 103 pass through the duct casing 102 or 112 of the heating unit 100, and make the heat exchanged in the drying heater 10. Accordingly, the high temperature dry air is supplied into the drum of the laundry drying machine.

In the case that the heater employing the strip style surface-shaped heat generation member 13 as illustrated in FIG. 2A is applied as the drying heater 10, the temperature response property is very fast, since the strip style surface-shaped heat generation member 13 is made of a low thermal density metal thin plate strip, that is, the superficial area of the strip style surface-shaped heat generation member 13 is large. As a result, the drum internal temperature reaches a preset reference temperature T_{R} within about twenty seconds after the electric power has been applied.

Meanwhile, the controller 23 compares the drum internal temperature T which has been detected via the temperature sensor 22 with the preset reference temperature T_{R} (S14). When the drum internal temperature T is smaller than the preset reference temperature T_{R} at step S14, the drying heater 10 is continuously driven according to the first electric power.

That is, when the drum internal temperature T is smaller than the preset reference temperature T_{R} at step S14, the program proceeds to a step S18. The controller 23 judges humidity, etc. of washes according to a well-known judgment method. If it is judged that the washes are not completely dried, the program proceeds to a step S12, and thus the drying heater 10 is continuously driven according to the first electric power.

In this case, the reference temperature T_{R} is established into for example 100° C.

However, when the drum internal temperature T is larger than the preset reference temperature T_{R} at step S14, the controller 23 generates a signal having “1” as a logic level of the heater control signal S_{H} and supplies the same to the switching unit 28. Accordingly, in the case of the relay used as the switching unit 28, the moving contact 28a is exchanged to the second input 28c which is an A contact point. Accordingly, the second voltage and the second electric current (that is, the second electric power) from the second drive power supply 27, for example, the second electric power of AC voltage of 120V and electric current of 4.95 A is applied to the drying heater 10 (S15). That is, the electric power that is applied to the drying heater 10 from the second drive power supply 27 is established into about 595 W.

A single drive power supply is used to drive a heater in a general laundry drying machine. Thus, in the case that the drum internal temperature T is larger than the preset reference temperature T_{R}, the controller intercepts electric power from being supplied for the heater.

If the drive power supply for the drying heater 10 is changed from the first voltage/the first electric current (the first electric power) to the second voltage/the second electric current (the second electric power) which is relatively lower than the first voltage/the first electric current (the first electric power), as described above, calory that is produced from the drying heater 10 is not enough to keep the drum internal temperature T as the preset reference temperature T_{R}. As a result, the drum internal temperature T slowly descends.

Thereafter, as the drying heater 10 is driven by the second electric power, the temperature sensor 22 senses the drum internal temperature T (S16) if the drum internal temperature T descends, and supplies the sensed result to the controller 23.

As a result, the controller 23 compares the detected drum internal temperature T with the preset reference temperature T_{R} (S17). Thus, in the case that the drum internal temperature T is larger than the preset reference temperature T_{R}, the program proceeds to the step S15. Thus the drying heater 10 is continuously driven according to the second electric power. Meanwhile, in the case that the drum internal temperature T is smaller than the preset reference temperature T_{R}, the program proceeds to the step S18. The controller 23 judges whether or not washes are completely dried. If it is judged that the washes are not completely dried, the program proceeds to the step S12, and thus the drying heater 10 is continuously driven according to the first electric power. That is, the logic level of the heater control signal S_{H} is changed to “0” to then be supplied to the switching unit 28. Accordingly, the first electric power from the first drive power supply 26 is supplied to the drying heater 10. As a result, the drum internal temperature ascends again.

As described above, if the controller 23 judges that washes are not completely dried at step S18, the above-described procedures of the steps S12 to S18 are repeated, and the electric power from the first and second drive power supplies 26 and 27 is selectively applied to the drying heater 10 until washes are completely dried.

In addition, if the controller 23 judges that washes have been completely dried at step 18, electric power switches (not shown) for the first and second drive power supplies 26 and 27 which supply the electric power to the drying heater 10 are turned off. Thus, driving of the drying heater 10 is stopped, and driving of the blower motor 25 is halted. That is, all processing procedures related to a drying function are ended.

In the drying control system of the laundry drying machine of FIG. 5, the controller 23 directly controls the blower motor 25. However, the controller 23 may control the blower motor 25 through a well-known load driver. In addition, it is also possible to drive the blower motor 25 in association with a motor driving a drum instead of the blower motor 25.

In the drying control system of the laundry drying machine and the drying control method according to the first embodiment of the present invention which have been described with reference to FIGS. 5 and 6, the entire control operation has been described in view of a control system in the case of employing a double drive power supply mode.

Hereinbelow, a case of apply a drying heater according to the first embodiment of the present invention to a laundry drying machine will be compared with the conventional case, in order to explain drying characteristics.

### First Experimental Example

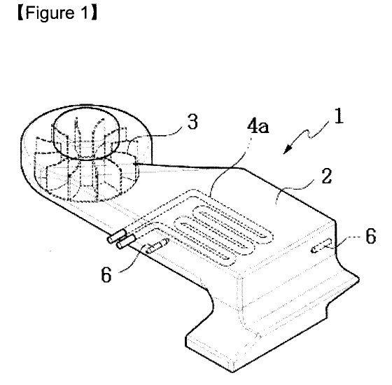

In the first experimental example, the drying heater employing the strip style surface-shaped heat generation members made of metal thin plates according to the embodiment of the present invention illustrated in FIG. 2A is used and is driven by a single drive power supply mode of 220V, but the sheath heater of FIG. 1 in the conventional case is used and driven by a single drive power supply mode of 220V.

For a comparison experiment, in the case of the embodiment of the present invention, only a sheath heater in a main body of a laundry drying machine (Model No. WD-DR351S) of LG Electronics Co., Ltd. which is a Korean electronics company is replaced by the drying heater according to the embodiment of the present invention and the single drive power supply mode of 220V is used as a drive power supply thereof. In the conventional case, the laundry drying machine (model No. WD-DR351S) of LG Electronics Co., Ltd., uses the sheath heater and the single drive power supply mode of 220V.

In both the case of the embodiment of the present invention and the conventional case, an identical test sample is used for measuring drying characteristics, in which a drying rate is set as 2.5%, respectively.

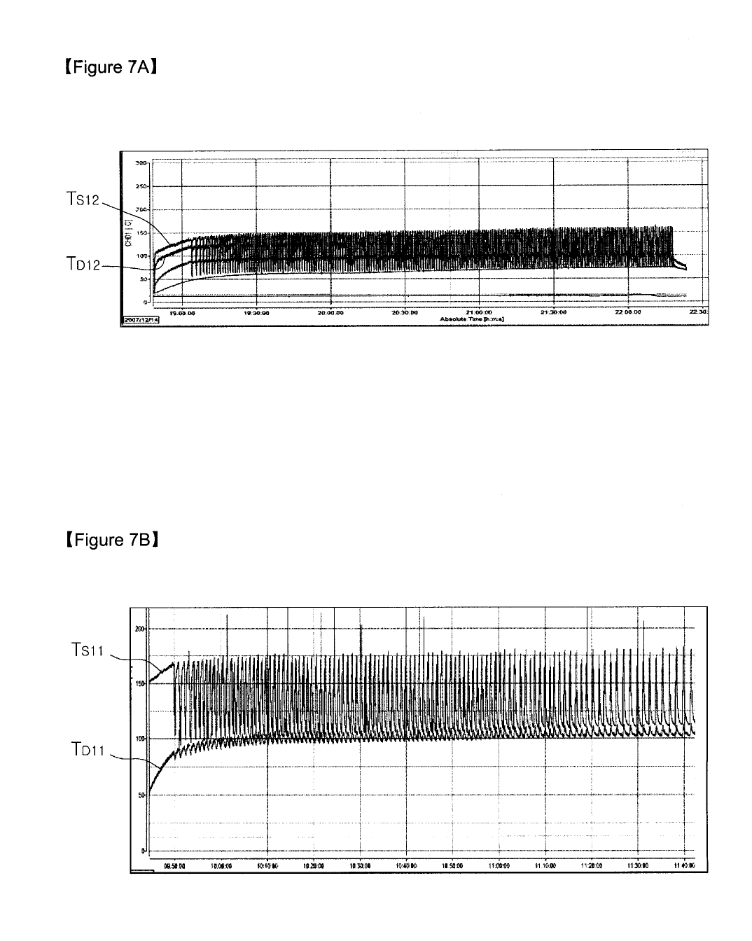

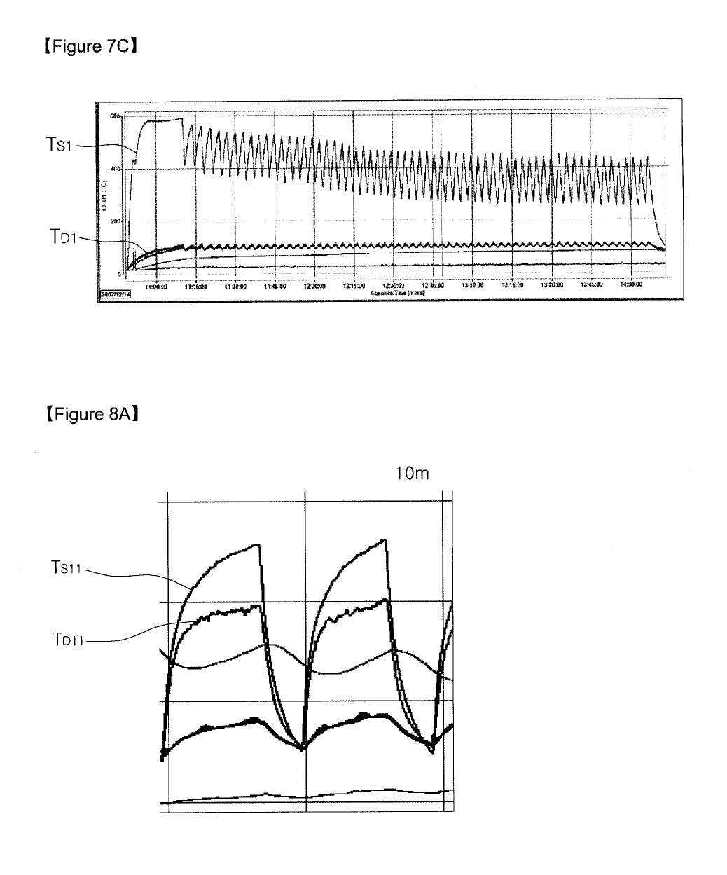

Graphs which are obtained by measuring heater surface temperatures T_{S12} and T_{S1} and drum supply temperatures T_{D12} and T_{D1} are illustrated in FIGS. 7A and 7C, in the case of the embodiment of the present invention and the conventional case, respectively. Drive conditions for the drying heater and drying characteristics for the measured results are summarized in the following Table 1.

TABLE 1

| | Conventional | The present invention | |
|---|---|---|---|
| | example | embodiments | Remarks |
| Heater class | Sheath heater | Strip style surface-shaped | |
| | | heat generation member | |
| Drive control | 220 V single drive | 220 V single | |
| mode | power supply | power supply | |
| Power | 2050 W | 1500 W | −550 W |
| Drum internal | 110° C. | 100° C. | −10° C. |
| tempertue | | | |
| Number of | 60 times | 200 times | +140 |
| switching times | | | |
| ON/OFF | 2 M 55 S/55 S | 35 S/22 S | |
| Switching period | | | |
| Drying time | 3 H 20 M | 3 H 30 M | +10 M |
| Electric power | 3720 WH | 3230 WH | 13.1% |
| consumption | | | |

As illustrated in Table 1, although the drying heater according to the present invention uses the single drive power mode of 220V as the drive power supply, a drying time increases by 25 minutes in comparison with the conventional case using the sheath heater and the single drive power supply mode of 220V. Nevertheless, it can be seen that electric power consumption is reduced by 13.1% despite lessening of the electric power capacity of the heater by 550 W.

As illustrated in FIG. 7A, the strip style surface-shaped heat generation member heater according to the present invention has caused the number of switching times, that is, the 200 switching times for the drying time of 3 hours 30 minutes due to the fast temperature response property thereof. However, as illustrated in FIG. 7C, the sheath heater of the conventional case has caused the number of switching times, that is, the 60 switching times for the drying time of 3 hours 20 minutes due to the slow temperature response property thereof.

In this case, it has appeared that a temperature rise time (ON period) is 35 seconds and a cooling time (OFF period) is 22 seconds, in the strip style surface-shaped heat generation member heater according to the present invention, but a temperature rise time (ON period) is 2 minutes 55 seconds and a cooling time (OFF period) is 55 seconds, in the sheath heater of the conventional case. It can be seen that the temperature rise time (ON period) and the cooling time (OFF period) of the conventional case are longer than those of the present invention. That is, the temperature rise time (ON period), in other words, a time (ON period) for supplying electric power for the heater according to the present invention is relatively shorter than that of the conventional case. Accordingly, it can be seen that the total electric power consumption of the heater according to the present invention is smaller than that of the conventional case.

### Second Experimental Example

In the second experimental example, the drying heater employing the strip style surface-shaped heat generation members made of metal thin plates according to the embodiment of the present invention illustrated in FIG. 2A is used and is driven by a double drive power supply mode shown in FIGS. 5 and 6, but the sheath heater of FIG. 1 in the conventional case is used and driven by a single drive power supply mode of 220V in the same manner as the first experimental example.

For a comparison experiment, in the case of the embodiment of the present invention, a sheath heater and a drive power supply of a laundry drying machine (Model No. WD-DR351S) of LG Electronics Co., Ltd. which is a Korean electronics company are replaced by the drying heater and the double drive power supply mode according to the embodiment of the present invention. In the conventional case, the laundry drying machine (model No. WD-DR351S) of LG Electronics Co., Ltd., uses the sheath heater and the single drive power supply mode of 220V as shown in FIG. 1 in the same manner as the first experimental example.

In both the case of the embodiment of the present invention and the conventional case, an identical test sample is used for measuring drying characteristics, in which a drying rate is set as 2.5%, respectively.

Graphs which are obtained by measuring heater surface temperatures T_{S11} and T_{S1} and drum supply temperatures T_{D11} and T_{D1} are illustrated in FIGS. 7B and 7C, in the case of the embodiment of the present invention and the conventional case, respectively. Drive conditions for the drying heater and drying characteristics for the measured results are summarized in the following Table 2.

TABLE 2

| | Conventional | The present | |
|---|---|---|---|
| | example | invention embodiment | [symbol] |
| Heater class | Sheath heater | Strip style thin film | |
| | | surface-shaped heat | |
| | | generation member | |
| Drive control | Single power | Double drive | |
| mode | supply | power supply | |
| Electric power | 2050 W | 2000 W/595 W | |
| Drum internal | 110° C. | 100° C. | −10° C. |
| temperature | | | |
| Number of | 60 times | 108 times | +48 |
| switching times | | | |
| Drying time | 3 H 20 M | 2 H 58 M | −22 M |
| Electric power | 3700 WH | 2920 WH | 21% |
| consumption | | | |

As illustrated in Table 2, in the case of the drying heater according to the present invention using the double drive power mode as the drive power supply according to the embodiment of the present invention reduces, it can be seen that a drying time decreases by 22 minutes in comparison with the conventional case using the sheath heater and the single drive power supply mode of 220V, and that electric power consumption is reduced by 21%.

As illustrated in FIG. 7B, the strip style surface-shaped heat generation member heater according to the present invention has caused the number of switching times, that is, the 108 switching times for the drying time of 2 hours 58 minutes due to the fast temperature response property thereof. However, as illustrated in FIG. 7C, the sheath heater of the conventional case has caused the number of switching times, that is, the 60 switching times for the drying time of 3 hours 20 minutes due to the slow temperature response property thereof.

In this case, it has appeared that a temperature rise time (ON period) is varied according to lapse of a drying time, in the strip style surface-shaped heat generation member heater according to the present invention, but an average temperature rise time (ON period) is 15 to 20 seconds which is taken until a drum internal temperature rises up to a preset temperature as a first voltage/a first electric current (that is, a first electric power) is applied as a drive power supply, and is shortened according to lapse of the drying time. Meanwhile, a cooling time (OFF period) increases according to lapse of the time as a second voltage/a second electric current (that is, a second electric power) is applied as a drive power supply.

In comparison, it can be seen that a temperature rise time (ON period) is 2 minutes 55 seconds and a cooling time (OFF period) is 55 seconds, in the sheath heater of the conventional case. That is, in the sheath heater of the conventional case, both the temperature rise time (ON period) and the cooling time (OFF period) are longer than those of the present invention, and do not differ greatly according to lapse of the time. In this case, a long temperature rise time (ON period) means a long power supply time.

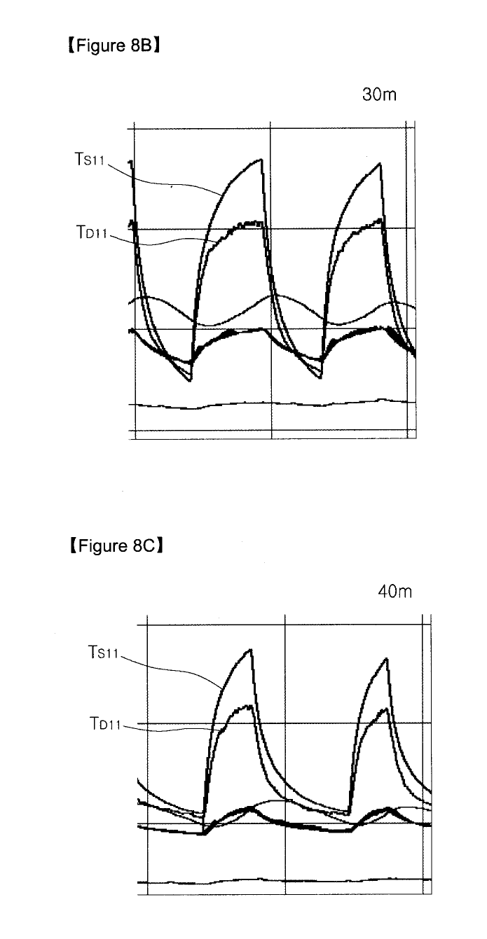

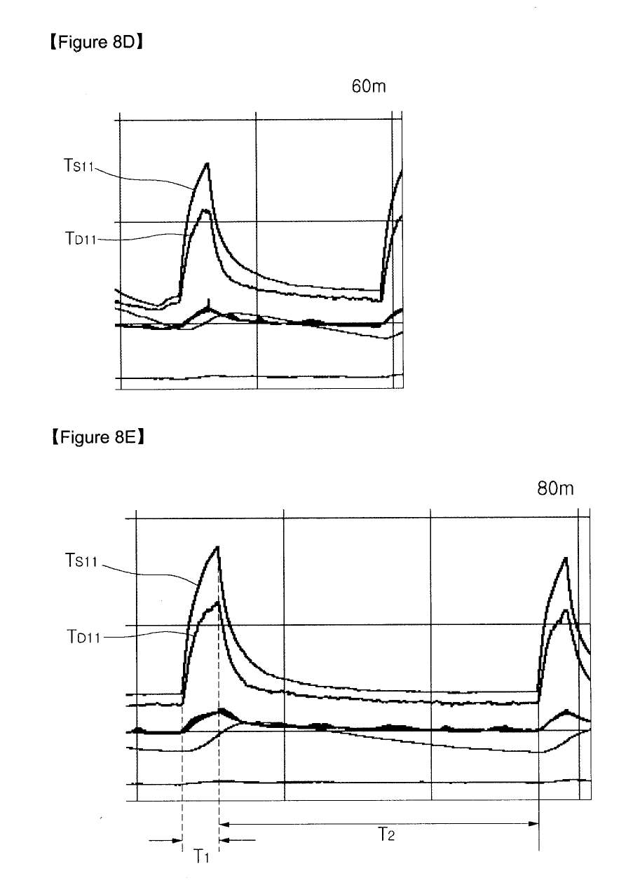

In addition, referring to FIGS. 8A to 8E, it can be seen that a ratio of a first period of time T1 during which a first voltage/a first electric current (that is, a first electric power) is applied and a second period of time T2 during which a second voltage/a second electric current (that is, a second electric power) is applied, as a drive power supply with respect to the drying heater according to the present invention, increases according to lapse of the drying time, and that a cycle during which the first period of time T1 and the second period of time T2 are repeated increases according to lapse of the drying time.

When referring to change of the heater surface temperature T_{S11}, the fact that the first period of time T1 during which the first electric power is applied is shortened according to lapse of the time, and the second period of time T2 during which the second electric power is applied is prolonged according to lapse of the time means that an electric power consumption required for keeping a preset temperature is decreased according as time passes.

Meanwhile, referring to FIGS. 7A to 7C, it has appeared the heater surface temperature T_{S1} of the surface-shaped heat generation member heater according to the present invention rises up to about 155-158° C., but the heater surface temperature T_{S2} of the conventional sheath heater rises up to about 580° C. Therefore, considering isolation from surrounding components, it is not so easy to design the conventional sheath heater having a high temperature heat generation property in a compact structure. On the contrary, the present invention heater may be little restricted from the above-described conventional structural limitation, and designed in a compact structure.

When reviewing the first and second experimental results, it can be confirmed that even the case that the drying heater according to the present invention is replaced into the sheath heater and the single drive power mode of 220V is used as the drive power supply may consume less electric power in comparison with the conventional case using the sheath heater.

However, in the case that the strip style thin film surface-shaped heat generation member whose temperature response property is fast, that is, whose temperature rise time and cooling time are short is employed as the drying heater, it can be confirmed that an electric power consumption is further reduced when a double drive power supply mode at which the heater is driven by a low electric power (that is, a low voltage/a low electric current), instead of a turn-off of an electricity so that the cooling temperature of the heater can be maintained at 90° C.-100° C. during a turn-off period (that is, a cooling period) of the heater.

### Second Embodiment

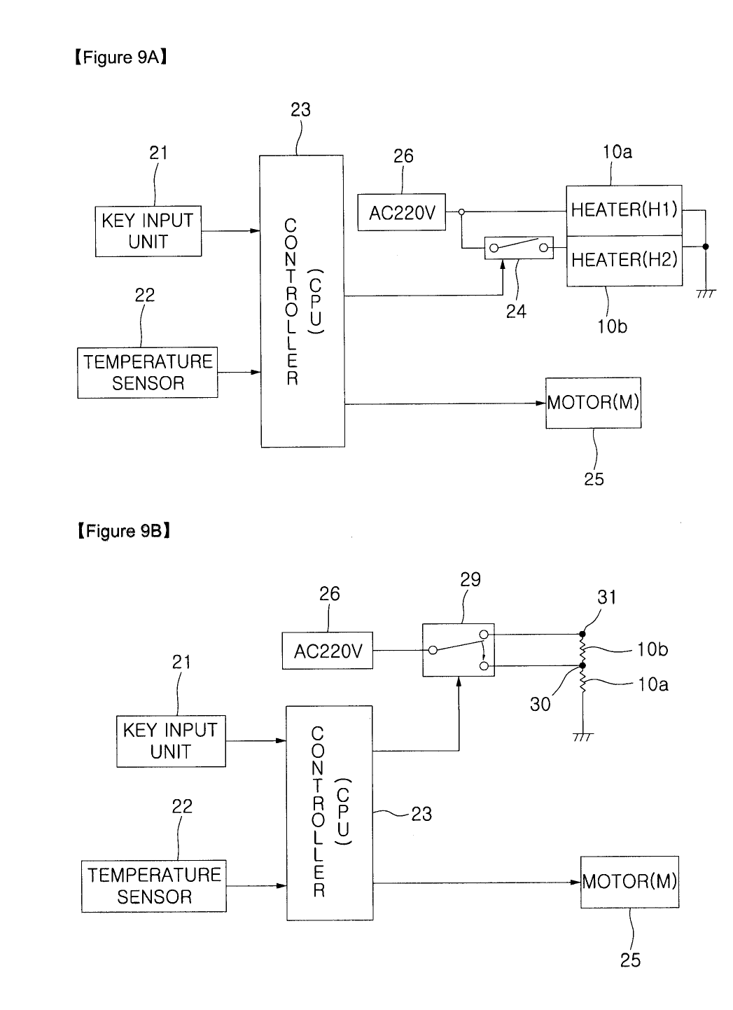

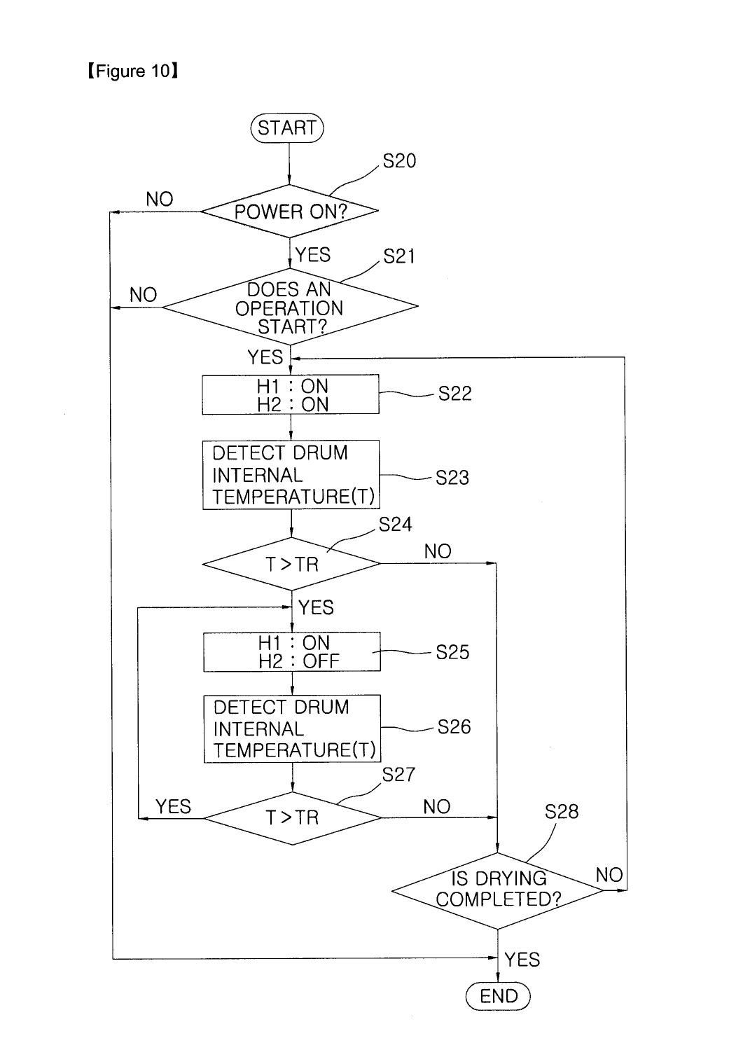

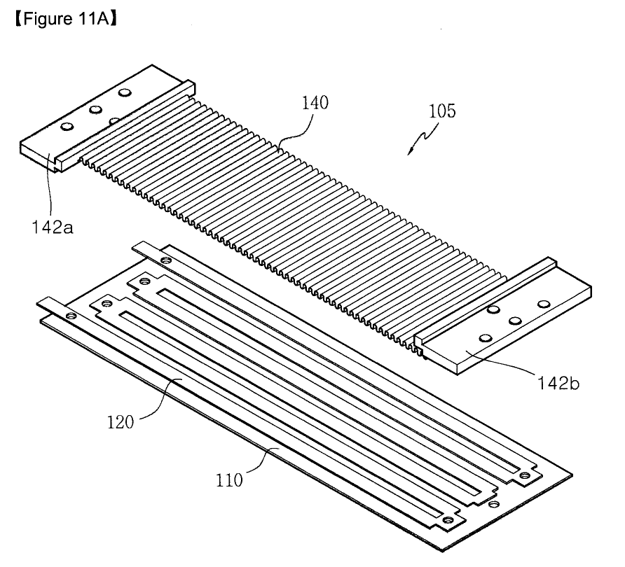

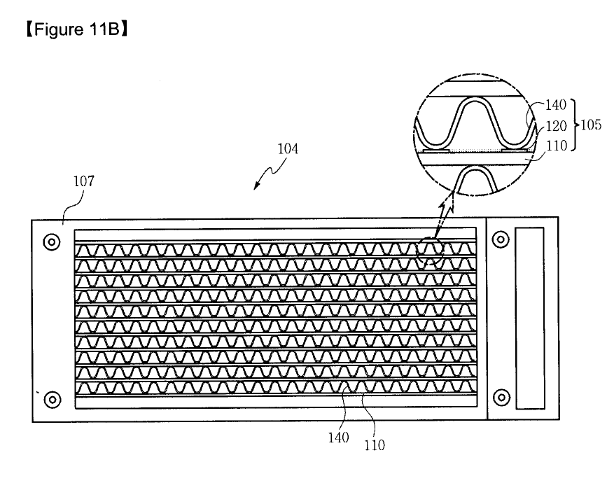

FIG. 9A is a schematic block diagram showing a drying control system of a laundry drying machine according to a second embodiment of the present invention, and FIG. 10 is a flowchart view for explaining a drying control method of the drying control system illustrated in FIG. 9A.

Referring to FIG. 9A, the drying control system of the laundry drying machine according to the second embodiment of the present invention includes: a key input unit 21 having a number of keys for inputting user's request commands; a temperature sensor 22 for detecting a drum internal temperature (T) of the laundry drying machine according to an operation on/off command which is input via the key input unit 21; and a controller (CPU (Central Processing Unit)) 23 which generates a heater control signal for driving first and second heaters (H1 and H2) 10a and 10b and simultaneously a blower motor driving signal for driving a blower fan 103, based on the current drum internal temperature (T) detected from the temperature sensor 22, if an operation start command is input via the key input unit 21, similarly to the first embodiment.

The controller 23 may employ for example a microcomputer having a first memory (for example, ROM (Read Only Memory)) storing a control program for executing a drying control method shown in FIG. 10, and a second memory (for example RAM (Random Access Memory)) storing temporary data during processing, or another well-known signal processing unit in which a memory device is detached from a processor.

To the output of the controller (CPU) 23 are connected a switching unit 24 which drives the first and second heaters (H1 and H2) 10a and 10b simultaneously or selectively according to a logic level of the heater control signal, that is, “0” and “1” and a blower motor (M) 25 to drive the blower fan 103 according to the blower motor driving signal for driving the blower fan 103.

The double drive power supply mode of AC 220V and AC 120V is employed in the first embodiment, but a single drive power mode of AC 220V is employed in the second embodiment. In the second embodiment, the first and second heaters (H1 and H2) 10a and 10b whose resistance values differ from each other are employed as the heaters, and the first and second heaters (H1 and H2) 10a and 10b are simultaneously driven and then any one of the first and second heaters (H1 and H2) 10a and 10b is selectively driven according to the drum internal temperature T, which repeats in operation.

For this, the output of the single drive power supply 26 is directly connected to the first heater 10a, and is connected to the second heater 10b via the switching unit 24. In this case, the output end of the single drive power supply 26 further includes a switch (not shown) which makes the output of the single drive power supply 26 applied to the first heater 10a and the switching unit 24, in response to a user's pressure of an operation key so that a drying operation can start.

In addition, the heater resistance value of the first heater H1 is set so that the electric power can be 515 W when an AC 220V voltage is applied to the first heater H1, and the heater resistance value of the second heater H2 is set so that the electric power can be 1405 W when the AC 220V voltage is applied to the second heater H2.

Here, in the case that a logic level of the heater control signal supplied from the controller 23 is “1,” the switching unit 24 is turned on and makes the AC 220V voltage from the single drive power supply 26 applied to both the first and second heaters (H1 and H2) 10a and 10b, but in the case that a logic level of the heater control signal supplied from the controller 23 is “0,” the switching unit 24 is turned off and makes the AC 220V voltage from the single drive power supply 26 applied to the first heater (H1) 10a. Thus, in the case that the AC 220V voltage from the single drive power supply 26 is applied to both the first and second heaters (H1 and H2) 10a and 10b, the electric power consumption is determined as 1920 W. In this case, the electric power of the first heater H1 is set as a suitable magnitude to prevent the drum internal temperature T from falling down sharply below 100° C.

The switching unit 24 is composed of a relay. Otherwise, a component such as a SCR (Silicone Controller Rectifier) and a TRIAC (triode AC switch) which are suitable for switching AC power may be used for the switching unit 24. Alternatively, it is possible to make a switching unit circuit using a thermostat instead of the switching unit 24 and the temperature sensor 22.

Hereinbelow, an operation of the laundry drying machine having the above-described structure according to the present invention will be described with reference to FIG. 10.

First, a user turns on an electric power supply via the key input unit 21. The electric power is supplied and operation of the laundry drying machine is at a stand-by state (S20).

Then, if the user selects a laundry drying condition through the key input unit 21, and then presses an operation key so as to start a drying operation (S21), the controller 23 recognizes user commands and supplies a heater control signal and a blower motor driving signal to the switching unit 24 and the blower motor 25, respectively, to thus turn on the switching unit 24. Accordingly, the single drive power supply 26 is connected to the second heater (H2) to thus make both the first and second heaters (H1 and H2) 10a and 10b and the blower motor 25 operate and to simultaneously receive a drum internal temperature (T) via the temperature sensor 22 (S22 and S23).

When the laundry drying machine is at an initial state, the controller 23 generates a signal that the logic level of the heater control signal is “1” to then be supplied to the switching unit 24. Thus, in this case, the switching unit 24 applies the AC 220V voltage, for example, from the drive power supply 26 to both the first and second heaters (H1 and H2) 10a and 10b.

Thus, the total electric power that is applied to the both the first and second heaters (H1 and H2) 10a and 10b is established into about 1920 W. The applied electric power is established similarly to the power consumption used in a general laundry drying machine.

The first and second heaters (H1 and H2) 10a and 10b are operated according to application of the AC 220V voltage to thereby generate heat. Then, the blower motor 25 is operated, to thereby make air introduced by the blower fan 103 pass through the duct casing 102 or 112 of the heating unit 100, and make the heat exchanged in the first and second heaters (H1 and H2) 10a and 10b. Accordingly, the high temperature dry air is supplied into the drum of the laundry drying machine.

In the case that the heater employing the strip style surface-shaped heat generation member 13 as illustrated in FIG. 2A is applied as the first and second heaters (H1 and H2) 10a and 10b, the temperature response property is very fast, since the strip style surface-shaped heat generation member 13 is made of a low thermal density metal thin plate strip, that is, the superficial area of the strip style surface-shaped heat generation member 13 is large. As a result, the drum internal temperature reaches a preset reference temperature T_{R} within about twenty seconds after the electric power has been applied.

Meanwhile, the controller 23 compares the drum internal temperature T which has been detected via the temperature sensor 22 with the preset reference temperature T_{R} (S14). When the drum internal temperature T is smaller than the preset reference temperature T_{R} at step S24, the first and second heaters (H1 and H2) 10a and 10b are continuously driven.

That is, when the drum internal temperature T is smaller than the preset reference temperature T_{R} at step S14, the program proceeds to a step S28. The controller 23 judges humidity, etc. of washes according to a well-known judgment method. If it is judged that the washes are not completely dried, the program proceeds to a step S22, and thus the first and second heaters (H1 and H2) 10a and 10b are continuously driven under the identical condition.

In this case, the reference temperature T_{R} is established into for example 100° C.

If the first and second heaters (H1 and H2) 10a and 10b are simultaneously driven, the drum internal temperature T rises up. If time passes by about 20 seconds, the drum internal temperature T rises up above the reference temperature T_{R}.

Thus, if the drum internal temperature T is compared with the reference temperature T_{R}, the drum internal temperature T is larger than the reference temperature T_{R}. In this case, the controller 23 generates a signal having “0” as a logic level of the heater control signal and supplies the same to the switching unit 24. Accordingly, the switching unit 24 is turned off, and the electric power is not supplied to the second heater 10b but is supplied to only the first heater 10a.

A single drive power supply is used to drive a single heater in a general laundry drying machine. Thus, in the case that the drum internal temperature T is larger than the preset reference temperature T_{R}, the controller intercepts electric power from being supplied for the single heater.

However, when a drying operation is performed in the embodiment of the present invention, the electric power is continuously supplied to the first heater 10a, to thus maintain a heat generation state. The electric power for the second heater 10b is repeatedly supplied or intercepted when the switching unit 24 is turned on or off according to the drum internal temperature T.

If the switching unit 24 is turned off and the drive power supply for the second heater 10b is intercepted, calorie that is produced from the first heater 10a is not enough to keep the drum internal temperature T as the preset reference temperature T_{R}. As a result, the drum internal temperature T slowly descends.

Thereafter, as the drum internal temperature T slowly descends, the temperature sensor 22 senses the drum internal temperature T (S26), and supplies the sensed result to the controller 23.

As a result, the controller 23 compares the detected drum internal temperature T with the preset reference temperature T_{R} (S27). Thus, in the case that the drum internal temperature T is larger than the preset reference temperature T_{R}, the program proceeds to the step S25. Thus, only the first heater 10a is continuously driven. Meanwhile, in the case that the drum internal temperature T is smaller than the preset reference temperature T_{R}, the program proceeds to the step S28. The controller 23 judges whether or not washes are completely dried. If it is judged that the washes are not completely dried, the program proceeds to the step S22, and thus both the first and second heaters 10a and 10b are continuously driven. That is, the logic level of the heater control signal is changed to “1” to then be supplied to the switching unit 24. Accordingly, the AC 220V voltage is supplied to the first and second heaters 10a and 10b. As a result, the drum internal temperature ascends again.

As described above, if the controller 23 judges that washes are not completely dried at step S28, the above-described procedures of the steps S212 to S28 are repeated, and a 2-heater driving state where the first and second heaters 10a and 10b are simultaneously driven and a 1-heater driving state where only one heater of the first and second heaters 10a and 10b is selectively driven, is repeated, until washes are completely dried.

In addition, if the controller 23 judges that washes have been completely dried at step 28, electric power switches (not shown) for supplying the heaters with the electric power are turned off. Thus, driving of the first and second heaters 10a and 10b is stopped, and driving of the blower motor 25 is halted. That is, all processing procedures related to a drying function are ended.

### Third Embodiment

FIG. 9B is a schematic block diagram showing a drying control system of a laundry drying machine according to a third embodiment of the present invention.

There is a difference that, in the second embodiment, the first and second heaters 10a and 10b are connected in parallel with each other, but in the third embodiment, the first and second heaters 10a and 10b are connected in series with each other.

That is, in the third embodiment, the first and second heaters 10a and 10b are connected in series with each other between the single drive power supply (AC 220V) 26 and the ground, and a switching unit 29 is connected to the single drive power supply (AC 220V) 26 selectively at one end 31 of the second heater 10b and a connection point 30 between the first and second heaters 10a and 10b.

The controller (CPU) 23 controls the heater control signal to be applied to the switching unit 29 according to the drum internal temperature T similarly to the second embodiment. Accordingly, the controller (CPU) 23 controls the drive power supply 26 to be connected to one end of the second heater 10b to thereby control the first and second heaters 10a and 10b to be simultaneously driven. Otherwise, the controller (CPU) 23 controls the drive power supply 26 to be connected to a connection point 30 between the first and second heaters 10a and 10b to thereby control only the first heater 10a to be driven.

The switching unit 29 is composed of a relay. Otherwise, a component such as a SCR (Silicone Controller Rectifier) and a TRIAC (triode AC switch) which are suitable for switching AC power may be used for the switching unit 29.

A drying control system of a laundry drying machine according to the third embodiment of the present invention performs a control of a heater according to a drying control method illustrated in FIG. 10. Since the drying control method according to the third embodiment is equal to that of the second embodiment except that the controller (CPU) 23 controls the switching unit 29 instead of the switching unit 24, the detailed description thereof will be omitted.

When a first period T1 during which the first and second heaters 10a and 10b are simultaneously driven is compared with a second period T2 during which only the first heater 10a is driven, in the second and third embodiments of the present invention, similarly to the first embodiment of the present invention, length of the second period T2 is increased according to lapse of the drying time. In addition, it has appeared that a cycle of repeating the first period T1 and the second period T2 is increased according to lapse of the time.

Meanwhile, the above-described embodiments have been described with respect to the structures that the drying heater 10 for the laundry drying machine includes the first through third unit heaters 15a-15c, that is, the three unit heaters, respectively having the strip style surface-shaped heat generation members 13 are combined on the upper and lower surfaces of the first through third base members 12a-12c, that is, the three base members, but the drying heater 10 can be varied as follows.

E. Drying Heater Variation Examples

### First Variation Example

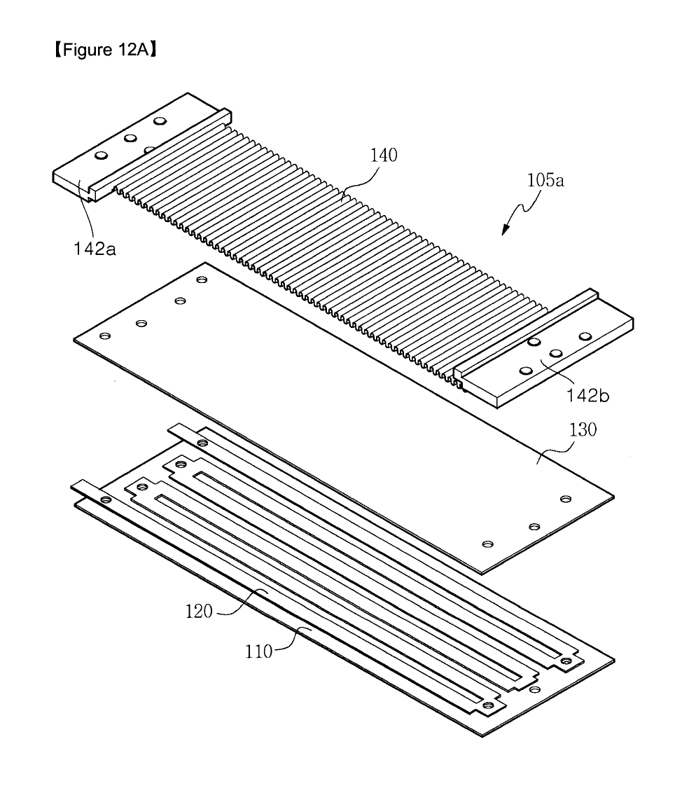

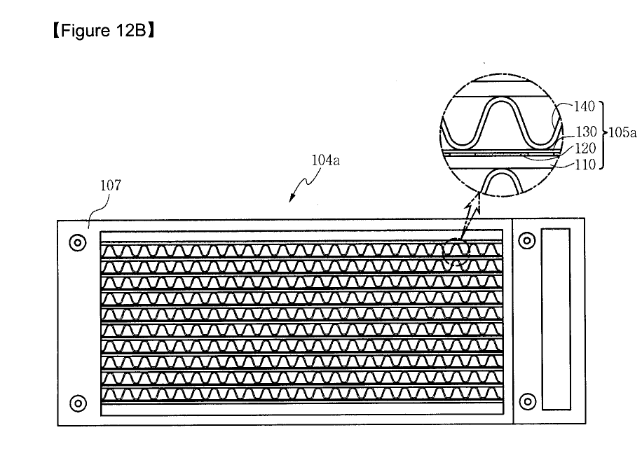

As shown in FIG. 11A, in the case of a drying heater 104 according to a first variation of the present invention, a unit heater 105 includes a surface-shaped heat generation member 120 which is mounted on a plate style base member 110 having a flat plate shape, and a corrugation plate style heat radiation member 140 which is mounted on the upper portion of the surface-shaped heat generation member 120.

The surface-shaped heat generation member 120 is formed of a metal thin plate which is manipulated in a zigzag pattern. Both side ends of the surface-shaped heat generation member 120 are fixed on the upper portion of the base member 110 by fixing screws or joint bolts. In addition, first and second connection members 142a and 142b are combined with both side ends of the heat radiation member 140. The heat radiation member 140 is fixed on the surface-shaped heat generation member 120 and both side ends of the base member 110 which are disposed under the lower side of the heat radiation member 140, through the first and second connection members 142a and 142b, by fixing screws or joint bolts.

The plate style base member 110 is formed of an aluminum plate (110 mm*55 mm) on the surface of which is anodized to form an alumina insulation film. Accordingly, the plate style base member 110 is electrically insulated against a voltage of 5 kV. The heat radiation member 140 is formed by corrugating an aluminum plate on the surface of which is anodized to form an alumina insulation film.

As illustrated in FIG. 11B, a number of the unit heaters 105 are overlaid in a rectangular heater housing 107, for example 10 stories are laid over one another. An interval is formed on the upper and lower portions of the upper-most and the lower-most unit heaters 105, respectively, to thus form a drying heater 104.

The drying heater 104 transmits heat that is produced from the surface-shaped heat generation member 120 to the plate style heat radiation member 140, when a voltage is applied to both ends of the surface-shaped heat generation member 120. Ambient air is equally heated by the heated plate style heat radiation member 140.

That is, air that is introduced into the inside of the duct casing member 102 by operation of the blower fan 103 as shown in FIG. 4A is heated while passing through the plate style heat radiation member 140, and then discharged into the inside of the drum, to thereby dry washes.

### Second Variation Example

As shown in FIG. 12A, in the case of a drying heater 104a according to a second variation of the present invention, a unit heater 105a includes a surface-shaped heat generation member 120 which is mounted on a plate style base member 110 having a flat plate shape, and a plate style thermal conductive member 130 and a corrugation plate style heat radiation member 140 which are in turn mounted on the upper portion of the surface-shaped heat generation member 120.

The plate style thermal conductive member 130 is formed of an aluminum plate (110 mm*55 mm) on the surface of which is anodized to form an anode oxide film, that is, an alumina (Al₂O₃) insulation film. Besides, since the plate style base member 110 and the surface-shaped heat generation member 120 are identical to those of the first variation, the detailed description thereof will be omitted.

The surface-shaped heat generation member 120 is formed of a metal thin plate which is manipulated in a zigzag pattern. In addition, first and second connection members 142a and 142b are combined with both side ends of the heat radiation member 140. The heat radiation member 140 is fixed on both side ends of the thermal conductive member 130, the surface-shaped heat generation member 120, and the base member 110 which are disposed under the lower side of the heat radiation member 140, through the first and second connection members 142a and 142b, by fixing screws or joint bolts.

In the case of the unit heater 105a, the plate style thermal conductive member 130 is inserted between the surface-shaped heat generation member 120 and the plate style heat radiation member 140. Accordingly, the corrugation plate style heat radiation member 140 does not directly contact the surface-shaped heat generation member 120, and portions contacting an air layer are heat-transferred by conduction. As a result, a partially overheated phenomenon that is called a hot spot may prevented from occurring in the case that a high temperature is needed, and heat of the surface-shaped heat generation member 120 is uniformly transferred to the plate style heat radiation member 140, to thereby heighten a heat transfer efficiency.

As illustrated in FIG. 12B, a number of the unit heaters 105a are overlaid in a rectangular heater housing 107, for example, 10 stories are laid over one another. An interval is formed on the upper and lower portions of the upper-most and the lower-most unit heaters 105a, respectively, to thus form a drying heater 104a.

The drying heater 104a according to the second variation transmits heat that is produced from the surface-shaped heat generation member 120 to the plate style heat radiation member 140, in which a voltage is applied to both ends of the surface-shaped heat generation member 120. Ambient air is equally heated by the heated plate style heat radiation member 140.

### Third Variation Example

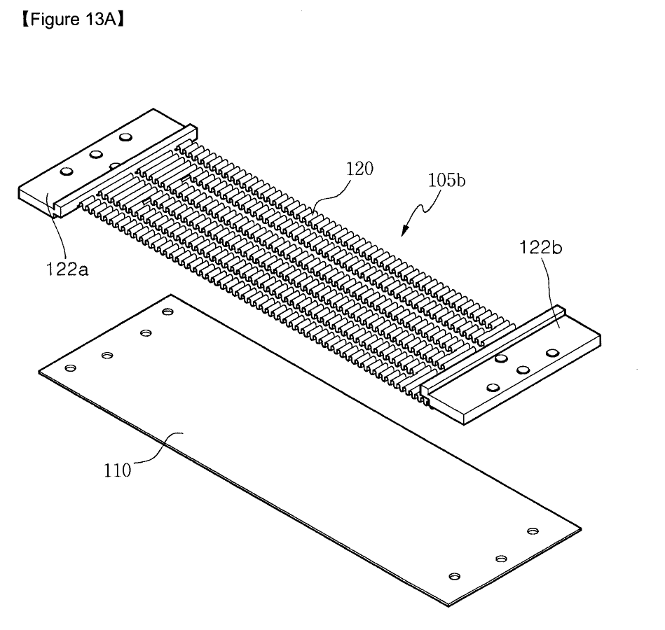

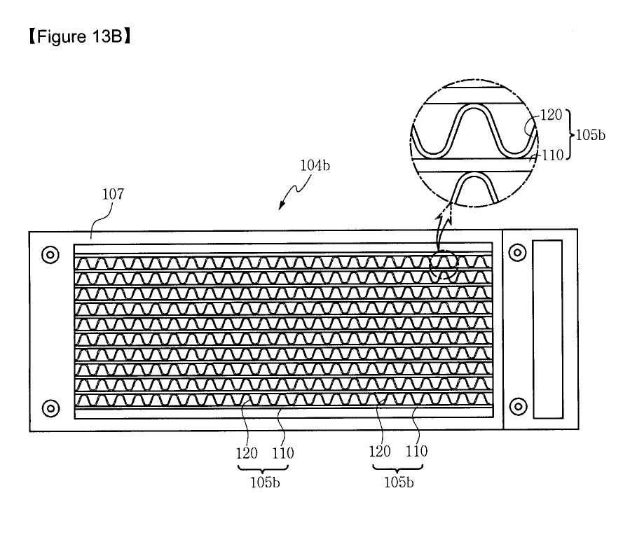

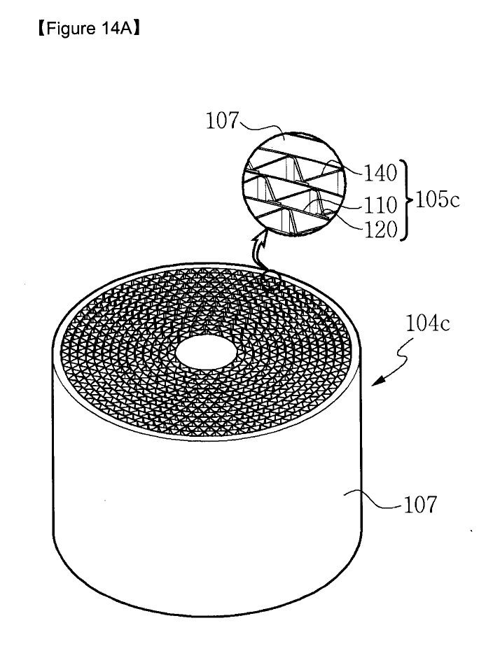

As shown in FIG. 13A, in the case of a drying heater 104b according to a third variation of the present invention, a unit heater 105b includes a surface-shaped heat generation member 120 which is mounted on a plate style base member 110 having a flat plate shape, and on the upper portion of which corrugation heat radiation pins are overlaid.

The surface-shaped heat generation member 120 is formed of a metal thin plate which is manipulated in a zigzag pattern. In addition, first and second connection members 122a and 122b are combined with both side ends of the surface-shaped heat generation member 120. The surface-shaped heat generation member 120 is fixed on both side ends of the base member 110 which is disposed under the lower side of the heat surface-shaped heat generation member 120, through the first and second connection members 122a and 122b, by fixing screws or joint bolts.

The plate style base member 110 is formed of an aluminum plate whose both surfaces are anodized to form an anode oxide film which is electrically insulated against a voltage of 5 kV, respectively.

The surface-shaped heat generation member 120 of the unit heater 105b has a heat radiation fin shape. When a voltage is applied to both ends of the surface-shaped heat generation member 120, the generated heat is directly exchanged with ambient air to thus heat the ambient air.

As illustrated in FIG. 13B, a number of the unit heaters 105b are overlaid in a rectangular heater housing 107, for example, 10 stories are laid over one another. An interval is formed on the upper and lower portions of the upper-most and the lower-most unit heaters 105b, respectively, to thus form a drying heater 104b.

In the first through third variation examples, the plate style base member 110 is formed by patterning the surface-shaped heat generation member 120 on a first insulation surface which is formed by insulating-processing one surface of the plate style base member 110.

The plate style base member 110 is made of aluminum or aluminum alloy whose thermal conductivity is high. Besides, any materials whose thermal conductivities are high and which resist a heat generation temperature of the surface-shaped heat generation member 120 may be applied as the plate style base member 110.

In addition, at least one surface of both surfaces of the plate style base member 110 is anodized, to form an insulation surface having an insulation and anti-oxidation function. The surface-shaped heat generation member 120 is formed on the insulation surface. Accordingly, the surface-shaped heat generation member 120 is insulated from the plate style base member 110.

In addition, the surface-shaped heat generation member 120 may be patterned and integrally attached on the insulation surface of the plate style base member 110. Alternatively, a separately fabricated surface-shaped heat generation member 120 may be mounted on the plate style base member 110.

The surface-shaped heat generation member 120 may be formed in a flat plate form, or may be formed in a corrugation heat radiation fin shape. In the case of the surface-shaped heat generation member 120 of the corrugation heat radiation fin shape, the surface-shaped heat generation member may be corrugated in a variety of heat radiation fin shapes in order to widen a contact area contacting air. In addition, one surface of the surface-shaped heat generation member 120 may be thermally treated, and an oxide film may be formed on the thermally treated surface of the surface-shaped heat generation member 120. Otherwise, an insulation material may be coated on the thermally treated surface of the surface-shaped heat generation member 120. Accordingly, the surface-shaped heat generation member 120 may be insulated from the plate style base member 110 or the plate style thermal conductive member 130 to be described later.

The drying heater 104, 104a or 104b according to the embodiment of the present invention includes a number of the unit heaters 105, 105a or 105b which are overlaid over one another, and includes an electrode terminal that which enables an electrical connection between the surface-shaped heat generation members 120 of the different unit heaters 105, 105a or 105b, when two or more unit heaters 105, 105a or 105b are combined with each other.

In addition, in the case that the surface-shaped heat generation members 120 of the respective unit heaters 105, 105a or 105b are circularly overlaid in a circular or oval casing, there may be no contact point between the electrode terminals. Otherwise, there may be one or more contact points between the electrode terminals, by welding or adhesion, as necessary.

The plate style heat radiation member 140 which is formed in a corrugation heat radiation fin shape is provided on the upper portion of the surface-shaped heat generation member 120. This plate style heat radiation member 140 may be formed in a corrugation style, that is, a waveform that peaks and valleys are repeated, as described above. However, the plate style heat radiation member 140 may be formed in any forms which are formed by bending a metal plate having a high thermal conductivity to thus widen a contact area with ambient air.

In addition, the plate style heat radiation member 140 may be desirably made of aluminum or aluminum alloy whose thermal conductivity is high. More preferably, both surfaces of the plate style heat radiation member 140 are anodized, and an anti-oxidation material and an insulation material are formed on the anodized surfaces of the plate style heat radiation member 140. The plate style heat radiation member 140 may allow air to pass through bent portions, and enable an efficient heat exchange with a wide contact area, to thereby enable heat ambient air quickly.

It is desirable that a plate style thermal conductive member 130 that transmits heat of the surface-shaped heat generation member 120 efficiently to the plate style heat radiation member 140 is provided between the surface-shaped heat generation member 120 and the plate style heat radiation member 140.

The plate style thermal conductive member 130 may be desirably made of aluminum or aluminum alloy whose thermal conductivity is high. More preferably, both surfaces of the plate style thermal conductive member 130 are anodized, and an anti-oxidation material and an insulation material are formed on the anodized surfaces of the plate style thermal conductive member 130.

In the case that the drying heater 104, 104a or 104b according to the embodiment of the present invention includes a number of the unit heaters 105, 105a or 105b which are overlaid over one another, in a rectangular heater housing 107 and the unit heater 105, 105a or 105b includes the surface-shaped heat generation member 120, it may be implemented into a different way from the first through third variation examples. That is, each unit heater 105, 105a or 105b may be formed in a circular or oval shape, and then inserted into the inside of a circular or oval casing.

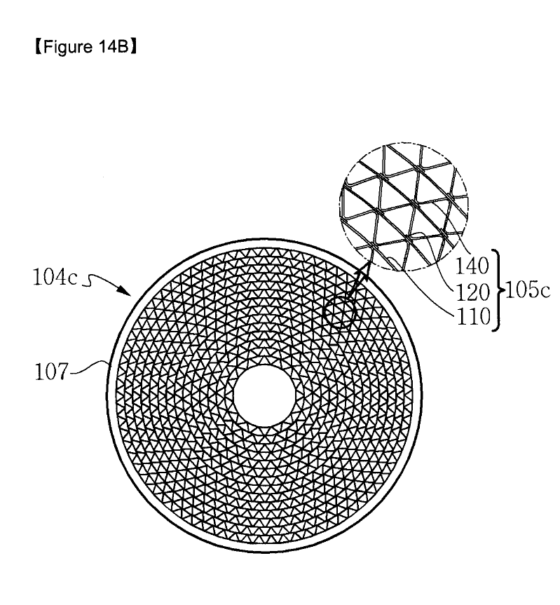

For example, as illustrated in FIGS. 14A and 14B, in the case of each unit heater 105c, a surface-shaped heat generation member 120 may provided on the upper portion of a plate style base member 110 having a flat plate shape. A corrugation plate style heat radiation member 140 may be overlaid on the upper portion of the surface-shaped heat generation member 120. Then, the unit heater 105c may be formed in a spiral or circular shape. Then, the spirally or circularly formed unit heater 105c is inserted in the inside of a cylindrical heater housing 107, to thus obtain a drying heater 104c.

That is, in differently from the drying heater 104 according to the first variation example of the present invention and illustrated in FIG. 11A, the unit heater 105 may be formed in a spiral or circular shape, and then packaged in the cylindrical heater housing 107.

The drying heater 104c may be formed by winding the plate style base member 110, the surface-shaped heat generation member 120, and the plate style heat radiation member 140 using a winding machine, simultaneously, putting the wound members 110, 120 and 140 into the cylindrical heater housing 107, and attaching electrode terminals to proper portions of the surface-shaped heat generation member 120.

In addition, it is preferable that the drying heater 104c is formed by removing a hole to be formed at the center of the cylindrical heater housing 107 or lessening size of the hole to be formed at the center of the cylindrical heater housing 107 when the unit heater 105c is wound in the cylindrical heater housing 107 so that air can pass the unit heater 105c to thus heat the air.

When a voltage is applied to both ends of the surface-shaped heat generation member 120, the drying heater 104c transmits heat that is produced from the surface-shaped heat generation member 120 to the corrugation plate style heat radiation member 140. Ambient air is heated by the heated plate style heat radiation member 140.

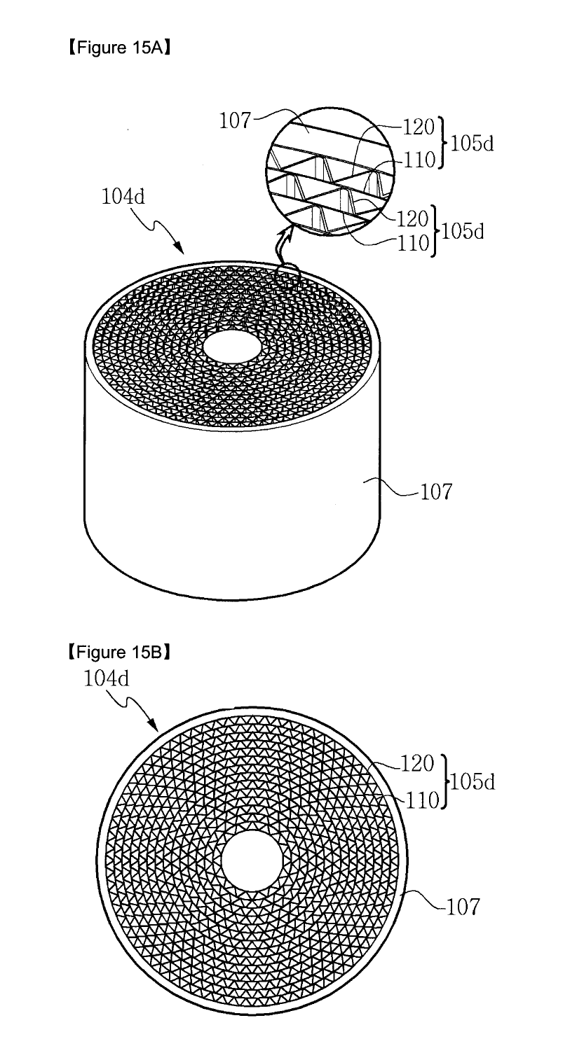

The drying heater 104c illustrated in FIGS. 14A and 14B is obtained by overlaying and winding the unit heater 105c formed of the plate style base member 110, the surface-shaped heat generation member 120 and the plate style heat radiation member 140. However, as illustrated in FIGS. 15A and 15B, it is possible to form a drying heater 104d by overlaying and winding a unit heater 105d formed of a plate style base member 110 and a corrugation surface-shaped heat generation member 120 in a spiral or circular form, in which the plate style heat radiation member 140 is removed from the unit heater 105c formed of the plate style base member 110, the surface-shaped heat generation member 120 and the plate style heat radiation member 140 illustrated in FIGS. 14A and 14B.

A wound assembly which is formed by overlaying and winding the unit heater 105d in a spiral or circular form is packaged in the inside of the cylindrical heater housing 107, to thereby form the drying heater 104d.

Meanwhile, the drying heater 104, 104a, 104b, 104c and 104d is used for a drying-purposed heating unit 100 which is installed in a washing machine or a laundry drying machine, to thus blow dry air into a wash drum.

Hereinbelow, the case where the drying heater 104, 104a, 104b, 104c and 104d is applied to the drying-purposed heating unit 100 used for the washing machine or laundry drying machine, will be compared with the case of employing the conventional sheath heater, to thus measure the comparison result, and then the experimental result will be described.

First, when there is no air flow in the inside of the duct casing 102 of the drying-purposed heating unit 100, temperature of the drying heater 104, 104a, 104b, 104c and 104d according to the present invention does not exceed 137° C. at maximum, but temperature of the drying heater rises up to 447° C. in the case of employing the conventional sheath heater. Therefore, the surface temperature of the dry duct casing appears to be very hot at 377.6° C.

When the drying heater 104, 104a, 104b, 104c and 104d according to the present invention and the conventional sheath heater is compared with each other to measure the comparison result, in the case that a blower fan 103 is acted in a heating unit 100, the drying heater 104, 104a, 104b, 104c and 104d according to the present invention maintains an air temperature of an air outlet 102b at 90° C. or so when the surface of the heater is at 120° C. or so. Meanwhile, the conventional sheath heater maintains the air temperature of the air outlet 102b at 90° C. or so when the surface of the heater is at 250° C. or so.

In the case of employing the drying heater 104, 104a, 104b, 104c and 104d of the present invention, the surface temperature of the duct casing 102 is measured at 27° C. or so, which is similar to the indoor temperature of a measurement space to thereby result in a very safe circumstance. However, in the case of the conventional sheath heater, the surface temperature of the duct casing 102 exceeds 130° C., and causes a very hot circumstance. This means that heat-resistant components should be used as components positioned at the surrounding portion of the duct casing.

In addition, the drying heater 104 of the present invention keeps the heat generation temperature at about 94° C. or so as the heat generation temperature, but the conventional sheath heater generates heat whose temperature rises up to 260° C. at the highest which is higher by 13-20° C. than 240° C. at which tree may be ignited. Accordingly, fire may break out in the case that a blower fan 3 stops or fails to operate.

In the case of the drying heater 104, 104a, 104b, 104c and 104d of the present invention, there is little loss of heat since difference in temperature is 6° C. or so between the temperature of the drying heater and the air temperature of the air outlet, to thus have a high energy efficiency. However, in the case of the sheath heater, an energy efficiency is low since difference in temperature is 150° C. or so between the temperature of the drying heater and the air temperature of the air outlet.

Electric power consumption, electric power, and line electric current are compared with respect to the respective cases of the drying-purposed heating units using the drying heater according to the present invention and the conventional sheath heater and the comparison measured results are illustrated in the following Table 3.

In this case, the electric power consumption is a measured value when a drying operation has been executed for 30 minutes which is a minimum established time at a drying mode of an ordinary drum type washing machine.

TABLE 3

| | Electric power | Consumed | Line | |
|---|---|---|---|---|
| Heater | consumption | electric power | current | Voltage |
| class | (Wh) | (W) | (Arms) | (Vac) |
| The | 469 | 926 | 4.18 | 220 |
| present | | | | |
| invention | | | | |
| Sheath | 1,058 | 2,108 | 9.59 | 220 |
| heater | | | | |

As described above, the electric power consumption of the drying heater according to the present invention is 469 Wh, but that of the conventional sheath heater is 1,058 Wh which is 2.2 times or more in comparison with the that of the drying heater according to the present invention.

Meanwhile, the drying heater 104, 104a, 104b, 104c and 104d which is employed in the drying-purposed heating unit 100 also adopts a strip style or a corrugation processed thin film surface-shaped heat generation member 120.

Therefore, the drying control system and the control method thereof according to the first and second embodiments of the present invention may adopt a double drive power supply mode which supplies different drive voltages from the double drive power supplies to the drying control system selectively, according to a preset drum internal temperature T so as to keep the drum internal temperature consistently and prevent the drum internal temperature from falling down sharply. Alternatively, the drying control system and the control method thereof according to the first and second embodiments of the present invention may adopt a single drive power supply mode, and instead may employ a 2-heater drive mode in which two heaters, that is, first and second heaters, whose heater resistance values differ from each other may be employed and both of the two heaters may be driven simultaneously according to a preset drum internal temperature T and then only one of the two heaters may be driven selectively. That is, the drying control system and the control method thereof according to the first and second embodiments of the present invention may be driven any one of the double drive power supply mode and the 2-heater drive mode.

In this case, as described above in the first and second embodiments of the present invention, if a thin film surface-shaped heat generation member is employed as a heat generation member of a heater, low temperature heat generation is accomplished due to the thin film surface-shaped heat generation member made of a low thermal density thin film strip, in comparison with a relatively thick surface-shaped heat generation member or coil-shaped heat generation member. However, heat exchange is accomplished in a wide area and an electric power consumption is reduced using a fast temperature response property.

### [Mode for Invention]

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, a drying heater, a heating unit for drying laundry using the same, a drying control system, and a control method thereof, which employs a metal thin film strip style surface-shaped heat generation member in a heater, with a double drive power supply mode, or single drive power supply mode and a 2-heater drive mode in which two heaters, that is, first and second heaters, whose heater resistance values differ from each other may be employed and both of the two heaters may be driven simultaneously according to a preset drum internal temperature and then only one of the two heaters may be driven selectively, to thereby control temperature of the inside of a drum, are applied in a washing machine having a drying function or a laundry drying machine.

1. A unit heater for use in a drying heater, the unit heater comprising:
a plate style base member having a thermal conductivity and an electric insulation feature; and
a low thermal density strip style surface-shaped heat generation member which is mounted on the plate style base member, and which is formed of a strip which is obtained by slitting a metal thin plate, to thus perform a heat generation operation when electric power is applied to both ends of the strip.

2. The unit heater according to claim 1, wherein the surface-shaped heat generation member is corrugated.

3. The unit heater according to claim 2, wherein the base member is formed of a number of coupling throughholes in a number of rows, in correspondence to width of the surface-shaped heat generation member, and the corrugated surface-shaped heat generation member is partially coupled with the number of the coupling throughholes of the base member.

4. The unit heater according to claim 1, further comprising a corrugation plate style heat radiation member which is in contact with the surface-shaped heat generation member in an insulated form, in which heat of the surface-shaped heat generation member is transferred.

5. The unit heater according to claim 1, further comprising:
a plate style thermal conductive member which is in contact with the surface-shaped heat generation member in an insulated form, in which heat of the surface-shaped heat generation member is transferred; and
a corrugation plate style heat radiation member which is in contact with the surface-shaped heat generation member in an insulated form, in which heat of the thermal conductive member is transferred.

6. The unit heater according to claim 1, wherein the base member is made of mica, or aluminum or an aluminum alloy on the surface of which an alumina insulation film is formed.

7. The unit heater according to claim 1, wherein the surface-shaped heat generation member is made of a FeCrAl-group alloy thin plate.

8. A drying heater comprising:
a vessel-shaped housing; and
a number of unit heaters which are formed at intervals in the inside of the housing,
wherein the number of the unit heaters respectively comprise:
a plate style base member having a thermal conductivity and an electric insulation feature; and
a low thermal density strip style surface-shaped heat generation member which is mounted on the plate style base member, and which is formed of a strip which is obtained by slitting a metal thin plate, to thus perform a heat generation operation when electric power is applied to both ends of the strip.

9. The drying heater according to claim 8, wherein the base member is formed of a number of coupling throughholes in a number of rows, in correspondence to width of the surface-shaped heat generation member, the surface-shaped heat generation member is corrugated, and the upper and lower sides of the corrugated surface-shaped heat generation member are partially coupled with the number of the coupling throughholes of the base member, on upper and lower surfaces of the base member.

10. The drying heater according to claim 8, wherein the base member is made of mica, or aluminum or an aluminum alloy on the surface of which an alumina insulation film is formed, and the surface-shaped heat generation member may be made of a FeCrAl-group alloy thin plate.

11. The drying heater according to claim 10, wherein the FeCrAl-group alloy thin plate is formed into a thickness of 20 to 500 μm.

12. A laundry drying-purposed heating unit comprising:
a duct casing member having an air inlet and an air outlet at both ends thereof, to thus form a path of guiding inhaled air into a drum;
a blower which is mounted in the inside of the duct casing member and which inhales air via the air inlet to then ventilate the inhaled air via the air outlet;
a drying heater which is mounted in the inside of the duct casing member and which heats air passing through an inner path,
wherein the drying heater comprises: a vessel-shaped housing; and
a number of unit heaters which are formed at intervals in the inside of the housing,
wherein the number of the unit heaters respectively comprise:
a plate style base member having a thermal conductivity and an electric insulation feature; and
a low thermal density strip style surface-shaped heat generation member which is mounted on the plate style base member, and which is formed of a strip which is obtained by slitting a metal thin plate, to thus perform a heat generation operation when electric power is applied to both ends of the strip.

13. The laundry drying-purposed heating unit according to claim 12, wherein the base member is formed of a number of coupling throughholes in a number of rows, in correspondence to width of the surface-shaped heat generation member, the surface-shaped heat generation member is corrugated, and the upper and lower sides of the corrugated surface-shaped heat generation member are partially coupled with the number of the coupling throughholes of the base member, on upper and lower surfaces of the base member.

14. A drying control system which supplies air heated at a preset temperature for the inside of a drum in a laundry drying machine or a wash drier, in order to dry laundry, the drying control system comprising:
a first drive power supply for applying a first electric power;
a second drive power supply for applying a second electric power that is lower relatively than the first electric power;
a drying heater having a surface-shaped heat generation member made of a low thermal density strip style metal thin plate;
a temperature sensor which detects drum internal temperature of the drying machine or wash drier; and
a controller which controls the first electric power of the first drive power supply to be applied to a drying heater in the case that the drum internal temperature is lower than a preset temperature, and controls the second electric power of the second drive power supply to be applied to the drying heater in the case that the drum internal temperature is higher than the preset temperature.

15. The drying control system according to claim 14, further comprising a switching unit which selectively applies any one of the first and second electric power to the drying heater according to a control signal that is applied from the controller.

16. The drying control system according to claim 14, wherein the voltage applied from the first drive power supply is AC 220V, and the voltage applied from the second drive power supply is AC 120V.

17. The drying control system according to claim 14, wherein the first electric power of the first drive power supply is established as a capacity which heats the drying heater and raises the drum internal temperature above the preset temperature, and the second electric power of the second drive power supply is established as a capacity which cannot raise the drum internal temperature above the preset temperature, when the drying heater is heated by only the second drive power supply.

18. The drying control system according to claim 14, wherein the drying heater comprises a number of unit heaters which are overlaid at intervals in the inside of a vessel-shaped housing, in which a surface-shaped heat generation member made of a metal thin plate is mounted in a plate style base member, respectively.

19. The drying control system according to claim 18, wherein the surface-shaped heat generation member is corrugated.

20. The drying control system according to claim 14, wherein the drying heater comprises:
a vessel-shaped housing; and
a number of unit heaters which are formed at intervals in the inside of the housing,
wherein the number of the unit heaters respectively comprise:
a plate style base member having a thermal conductivity and an electric insulation feature; and
a surface-shaped heat generation member which is formed of a metal thin plate and is insulated and mounted on the plate style base member, and which receives the electric power to thus perform a heat generation operation.

21. The drying control system according to claim 20, wherein the number of the unit heaters further comprise a corrugation style heat radiation member which is made of a thermal conductive material and is mounted on the upper portion of the surface-shaped heat generation member, respectively.

22. The drying control system according to claim 21, wherein the number of the unit heaters further comprises a plate style thermal conductive member which is made of a thermal conductive material and contacts between the surface-shaped heat generation member and the corrugation style heat radiation member, in an insulated form.

23. A drying control system which supplies air heated at a preset temperature for the inside of a drum in a laundry drying machine or a wash drier, in order to dry laundry, the drying control system comprising:
a single drive power supply;
a first drying heater which has a surface-shaped heat generation member made of a low thermal density strip style metal thin plate, and which performs a heat generation operation in correspondence to a first electric power when an electric power is applied from the drive power supply;
a second drying heater which has a surface-shaped heat generation member made of a low thermal density strip style metal thin plate, and which performs a heat generation operation in correspondence to a second electric power that is relatively higher than the first electric power when the electric power is applied from the drive power supply;
a temperature sensor which detects drum internal temperature of the drying machine or wash drier; and
a controller which controls the electric power of the drive power supply to be simultaneously applied to the first and second drying heaters in the case that the drum internal temperature is lower than a preset temperature, and controls the electric power of the drive power supply to be applied to only the first drying heater in the case that the drum internal temperature is higher than the preset temperature.

24. The drying control system according to claim 23, further comprising a switching unit which simultaneously applies the electric power to both the first and second drying heaters, or applies the electric power to only the first drying heater, according to a control signal that is applied from the controller.

25. The drying control system according to claim 23, wherein the first and second drying heaters are connected in series to or in parallel with each other.

26. The drying control system according to claim 23, wherein the first and second drying heaters are connected in parallel with each other, the first drying heater is connected directly to the drive power supply and the second drying heater is connected in the drive power supply through the switching unit that is established in a turn-on state selectively by the controller.

27. The drying control system according to claim 23, wherein the first and second drying heaters are connected in series to each other, a connection point between the first and second drying heaters and one end of the second drying heater is connected to the drive power supply through the switching unit.

28. The drying control system according to claim 23, wherein the surface-shaped heat generation member of the drying heater is corrugated.

29. A drying control method which supplies air heated at a preset temperature for the inside of a drum in a laundry drying machine or a wash drier, in order to dry laundry, the drying control method comprising:
supplying heated air for the inside of a drum of the laundry drying machine or wash drier by simultaneously applying the drive electric power to a first drying heater having a surface-shaped heat generation member made of a low thermal density strip style metal thin plate when an operation of the laundry drying machine or wash drier is initiated, and which performs a heat generation operation in correspondence to a first electric power when an electric power is applied from the drive power supply, and a second drying heater having a surface-shaped heat generation member made of a low thermal density strip style metal thin plate which performs a heat generation operation in correspondence to a second electric power which is relatively higher than the first electric power when the electric power is applied from the drive power supply;
detecting drum internal temperature of the laundry drying machine or wash drier; and
applying the electric power to both the first and second drying heaters when the drum internal temperature is lower than a preset temperature, or applying the electric power to only the first drying heater when the drum internal temperature is higher than the preset temperature.

30. The drying control method of claim 29, wherein the first and second drying heaters are connected in series to or in parallel with each other.

31. The drying control method of claim 29, wherein the resistance value of the first frying heater is relatively smaller than that of the second heater.

32. A drying control method which supplies air heated at a preset temperature for the inside of a drum in a laundry drying machine or a wash drier, in order to dry laundry, the drying control method comprising:
supplying heated air for the inside of a drum of the laundry drying machine or wash drier by applying a first electric power from a first drive power supply to a drying heater having a surface-shaped heat generation member made of a low thermal density strip style metal thin plate when an operation of the laundry drying machine or wash drier is initiated;
detecting drum internal temperature of the laundry drying machine or wash drier; and
applying the first electric power from the first drive power supply to a drying heater when the drum internal temperature is lower than a preset temperature, or applying a second electric power from a second drive power supply to the drying heater when the drum internal temperature is higher than the preset temperature in which the second electric power is relatively lower than the first electric power.

33. The drying control method of claim 32, wherein the voltage applied from the first drive power supply is AC 220V, and the voltage applied from the second drive power supply is AC 120V.

34. The drying control method of claim 32, wherein the first electric power of the first drive power supply is established as a capacity which heats the drying heater and raises the drum internal temperature above the preset temperature, and the second electric power of the second drive power supply is established as a capacity which cannot raise the drum internal temperature above the preset temperature, when the drying heater is heated by only the second drive power supply.

35. The drying control method of claim 32, wherein in the case of the drying heater, a proportion of a second period for which the second electric power of the second drive power supply is applied with respect to a first period for which the first electric power of the first drive power supply is applied increases according to passage of the drying time, and a period for which the first period and the second period are repeated increases.

36. The drying control method of claim 32, wherein the drying heater comprises a number of unit heaters which are laminated and layered at intervals in the inside of a vessel-shaped housing, in which a surface-shaped heat generation member made of a metal thin plate is mounted in a plate style base member, respectively.

37. A drying control method which controls a drying heater so that drum internal temperature of a drum in a laundry drying machine or a wash drier can be maintained at a preset temperature, the drying control method comprising:
applying a first electric power from a first drive power supply to the drying heater when the drum internal temperature is lower than the preset temperature, and applying a second electric power from a second drive power supply to the drying heater when the drum internal temperature is higher than the preset temperature in which the second electric power is relatively lower than the first electric power.

38. The drying control method of claim 37, wherein the drying heater comprises a surface-shaped heat generation member made of a low thermal density strip style metal thin plate.

39. A drying control method which controls a drying heater so that drum internal temperature of a drum in a laundry drying machine or a wash drier can be maintained at a preset temperature, the drying control method comprising:
applying an electric power to both first and second drying heaters when the drum internal temperature is lower than a preset temperature, and applying the electric power to only the first drying heater when the drum internal temperature is higher than the preset temperature.

40. The drying control method of claim 39, wherein the first drying heater comprises a surface-shaped heat generation member made of a low thermal density strip style metal thin plate, and performs a heat generation operation corresponding to a first electric power when the electric power is applied thereto, and the second drying heater comprises a surface-shaped heat generation member made of a low thermal density strip style metal thin plate, and performs a heat generation operation corresponding to a second electric power relatively higher than the first electric power when the electric power is applied thereto.

41. The drying control method of claim 39, wherein a resistance value of the first drying heater is smaller relatively than that of the second drying heater.
